(19) United States
(12) Patent Application Publication
(10) Pub. No.: US 2024/0334539 A1
(43) Pub. Date: Oct. 3, 2024

(54) CELL GLOBAL IDENTITY REPORTING TIMELINE FOR WIRELESS COMMUNICATIONS

(71) Applicant: QUALCOMM Incorporated, San Diego, CA (US)

(72) Inventors: Kuo-Chun LEE, San Diego, CA (US); Arvind Vardarajan SANTHANAM, San Diego, CA (US); Balakrishna YANAMADALA, San Diego, CA (US); Mona AGRAWAL, San Diego, CA (US); Hemanth Kumar RAYAPATI, San Diego, CA (US); Xiaoning LU, San Diego, CA (US); Tongxin WANG, Shanghai (CN); Anuj OJHA, San Diego, CA (US)

(21) Appl. No.: 18/681,296

(22) PCT Filed: Oct. 20, 2021
(86) PCT No.: PCT/CN2021/124933

§ 371 Date: Feb. 5, 2024

(51) Int. Cl. H04W 76/28; H04W 56/00

(52) U.S. Cl. CPC H04W 76/28; H04W 56/00

(57) ABSTRACT

Methods, systems, and devices for wireless communication are described. In some systems, a user equipment (UE) may divide a measurement of a cell into two or more portions. The UE may receive a control message that indicates a request to perform the measurement and a target frequency associated with the measurement. In some examples, the UE may generate at least a first radio frequency (RF) script during an on duration of a discontinuous reception (DRX) cycle based on the target frequency. The UE may perform at least a portion of the measurement during an off duration of the DRX cycle based on the first RF script. Additionally or alternatively, the UE may generate the first RF script and perform the portion of the measurement during an off duration of a DRX cycle and the UE may generate a second RF script during an off duration of a second DRX cycle.

### CROSS REFERENCE

The present Application is a 371 national stage filing of International PCT Application No. PCT/CN2021/124933 by LEE et al. entitled “CELL GLOBAL IDENTITY REPORTING TIMELINE FOR WIRELESS COMMUNICATIONS,” filed Oct. 20, 2021, which is assigned to the assignee hereof, and which is expressly incorporated by reference in its entirety herein.

### FIELD OF TECHNOLOGY

The following relates to wireless communication, including cell global identity (CGI) reporting timeline for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may operate in a discontinuous reception (DRX) mode, in which the UE may periodically cycle between a DRX on state and a DRX off state. A base station may transmit a request for the UE to perform a cell global identity (CGI) measurement within a configured time period. The UE may perform the CGI measurement while operating in the DRX off state. The UE may transmit a measurement report to the base station indicating the CGI or indicating a failure to successfully perform the CGI measurement within the configured time period.

### SUMMARY

The described techniques relate to improved methods, systems, devices, and apparatuses that support a cell global identity (CGI) reporting timeline for wireless communications. Generally, the described techniques provide for a user equipment (UE) to divide a CGI measurement into two or more portions to reduce latency associated with performing the measurement during discontinuous reception (DRX) communications. The UE may receive a control message from the network that includes a request for the UE to perform a measurement of a cell, such as a CGI measurement for the cell, and includes an indication of a target frequency associated with the measurement. In some examples, to perform the CGI measurement, the UE may generate at least a first radio frequency (RF) script during a first portion of a DRX cycle (e.g., an on duration of the DRX cycle) based on the target frequency. The UE may perform at least a portion of the CGI measurement during a second portion of the DRX cycle (e.g., an off duration of the DRX cycle) based on the first RF script. The portion of the CGI measurement may be associated with an acquisition of a synchronization signal at the target frequency. The UE may generate, during the first portion of the DRX cycle or during a third portion of a second DRX cycle (e.g., an on duration of the second DRX cycle), a second RF script associated with a system information block (SIB) acquisition. The first and second RF scripts may be or may include code or software that may configure one or more RF components of the UE with an RF configuration to receive the synchronization signal and the SIB, respectively.

In some examples, to perform the CGI measurement in response to the control message, the UE may generate a first RF script during a first portion of a first DRX cycle (e.g., an off duration of the DRX cycle) and acquire a synchronization signal during the first portion of the first DRX cycle at the target frequency based on the first RF script. The UE may subsequently generate a second RF script during a second portion of a second DRX cycle (e.g., an off duration of the second DRX cycle) based on information included in the synchronization signal. The UE may acquire a SIB during the second portion of the second DRX cycle based on the second RF script.

### BRIEF DESCRIPTION OF THE DRAWINGS

FIG. 1 illustrates an example of a wireless communications system that supports cell global identity (CGI) reporting timeline for wireless communications in accordance with aspects of the present disclosure.

FIG. 2 illustrates an example of a wireless communications system that supports CGI reporting timeline for wireless communications in accordance with aspects of the present disclosure.

FIGS. 3-7 illustrate examples of CGI measurement timelines that support CGI reporting timeline for wireless communications in accordance with aspects of the present disclosure.

FIGS. 8 and 9 illustrate examples of process flows that support CGI reporting timeline for wireless communications in accordance with aspects of the present disclosure.

FIGS. 10 and 11 show block diagrams of devices that support CGI reporting timeline for wireless communications in accordance with aspects of the present disclosure.

FIG. 12 shows a block diagram of a communications manager that supports CGI reporting timeline for wireless communications in accordance with aspects of the present disclosure.

FIG. 13 shows a diagram of a system including a device that supports CGI reporting timeline for wireless communications in accordance with aspects of the present disclosure.

FIGS. 14 through 18 show flowcharts illustrating methods that support CGI reporting timeline for wireless communications in accordance with aspects of the present disclosure.

### DETAILED DESCRIPTION

A wireless communications system may include communication devices, such as a base station (e.g., an eNodeB (eNB), a next generation NodeB or a giga NodeB, any of which may be referred to as a gNB, or some other base station) or a user equipment (UE) that may support multiple radio access technologies. Examples of radio access technologies include fourth generation (4G) systems, such as Long Term Evolution (LTE) systems, and fifth generation (5G) systems, which may be referred to as New Radio (NR) systems. In the wireless communications system, a UE may operate in a discontinuous reception (DRX) mode, in which the UE may cycle between DRX on durations and DRX off durations to reduce power consumption. The UE may communicate with one or more cells and report a physical cell identity (PCI) measurement for each cell to the network. The UE may, in some examples, receive a control message from the network that indicates a request for the UE to perform a cell global identity (CGI) measurement for a target frequency and a target cell based on a report of a PCI measurement for the cell. The UE may perform the CGI measurement during a DRX off duration to support continued throughput of communications during the DRX on durations.

To perform the CGI measurement, the UE may generate a first radio frequency (RF) script based on the target frequency, acquire a synchronization signal based on the first RF script, generate a second RF script based on information in the synchronization signal, and acquire a system information block (SIB) that contains the CGI based on the second RF script. The first and second RF scripts may include software or code that programs one or more RF components of the UE with a radio configuration (e.g., a frequency, bandwidth, or the like) to acquire a corresponding synchronization signal or SIB, respectively. In some cases, a duration of the CGI measurement may be greater than a DRX off duration, and the CGI measurement may fail. The UE may attempt the CGI measurement in subsequent DRX off durations until the CGI measurement succeeds or a configured timer expires. Such CGI measurement techniques may thereby be associated with relatively low reliaibility and relatively high latency and power consumption.

Techniques for improved CGI measurement during DRX communications are described herein. A UE may be configured to divide a CGI measurement procedure into two or more portions, or tasks, that may each be performed in different DRX on or off durations. The described CGI measurement techniques may provide for the UE to successfully complete the CGI measurement and transmit a measurement report indicating the CGI faster than if the UE does not perform the CGI measurement across multiple DRX on or off durations. In some examples, the UE may be configured to generate the first and second RF scripts during one or more DRX on durations. For example, the UE may generate the first RF script during a first DRX on duration and store the first RF script at the UE. The UE may subsequently acquire the synchronization signal during a DRX off duration based on the first RF script and generate the second RF script in a second DRX on duration based on the synchronization signal. Alternatively, the UE may be configured to pre-generate both the first RF script and the second RF script during a same DRX on duration. The UE may store the first and second RF scripts at the UE to use for performing the synchronization signal and SIB acquisitions, respectively, in one or more subsequent DRX off durations. In such cases, the UE may generate the second RF script based on a previous measurement associated with the target frequency.

In some other examples, the UE may be configured to divide the CGI measurement into a first portion including the first RF script generation and the synchronization signal acquisition and a second portion including the second RF script generation and the SIB acquisition. The UE may perform the first portion during a first DRX off duration and the second portion during a second DRX off duration, such that a duration of each portion may be less than the DRX off durations.

Particular aspects of the subject matter described herein may be implemented to realize one or more of the following potential advantages. By dividing the CGI measurement into two or more portions, a UE may reduce a processing time of the CGI measurement and increase a probability of success of CGI reporting using DRX off durations as compared with CGI measurements that are not divided into separate portions. For example, a duration of each portion of the CGI measurement may be less than a duration of a DRX off duration, which may provide for the UE to successfully complete each portion of the CGI measurement on a first attempt, or with relatively few attempts. By completing the CGI measurement faster, the UE may transmit a measurement report sooner and operate in an off state during more DRX off durations, which may provide for improved communication reliability and reduced power consumption. In some examples, the UE may pre-generate one or more RF scripts during a DRX on duration while performing other communications and store the RF scripts at the UE, which may improve efficiency and reduce latency of the CGI measurement.

Aspects of the disclosure are initially described in the context of wireless communications systems. Additional aspects of the disclosure are described with reference to CGI measurement configurations and process flows. Aspects of the disclosure are further illustrated by and described with reference to apparatus diagrams, system diagrams, and flowcharts that relate to CGI reporting timeline for wireless communications.

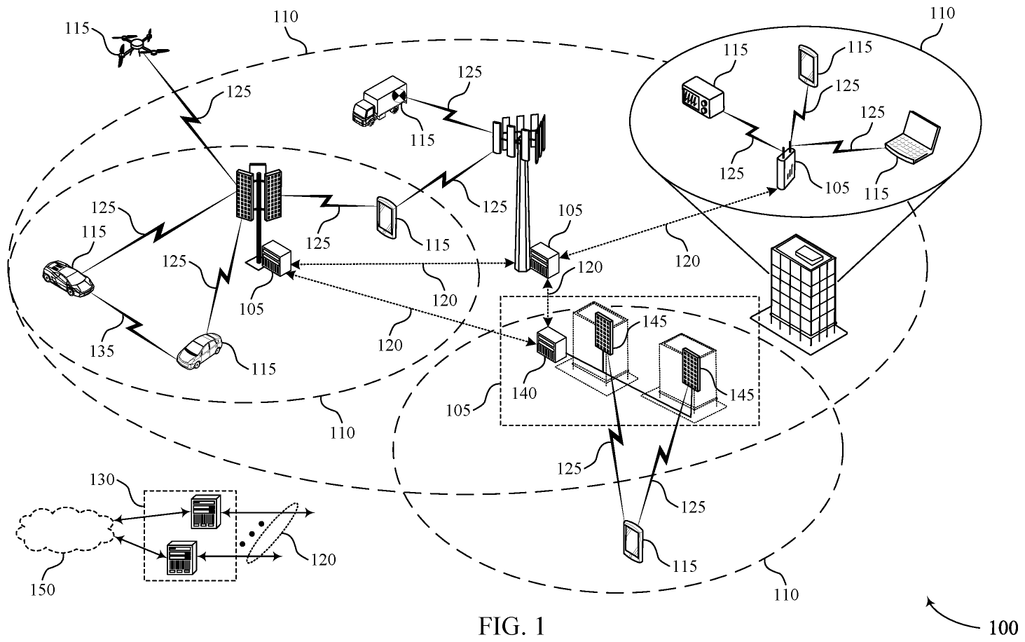

FIG. 1 illustrates an example of a wireless communications system 100 that supports CGI reporting timeline for wireless communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of RF spectrum resources having a defined physical layer structure for supporting the communication links 125. For example, a carrier used for a communication link 125 may include a portion of an RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the RF spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a RF spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Ns may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed RF spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support RF beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or RF beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a UE 115 as described herein may be configured to divide a CGI measurement into two or more portions to reduce latency associated with performing the CGI measurement during DRX communications. The UE 115 may receive a control message from the core network 130 (e.g., directly or via a base station 105 or some other network node) that includes a request for the UE 115 to perform a measurement of a cell (e.g., a CGI measurement for the cell), and includes an indication of a target frequency associated with the measurement. In some examples, to perform the CGI measurement, the UE 115 may generate at least a first RF script during a first portion of a DRX cycle (e.g., an on duration of the DRX cycle) based on the target frequency. The UE 115 may perform at least a portion of the CGI measurement during a second portion of the DRX cycle (e.g., an off duration of the DRX cycle) based on the first RF script. The portion of the CGI measurement may be associated with an acquisition of a synchronization signal at the target frequency. The synchronization signal may be a synchronization signal block (SSB), a secondary synchronization signal (SSS), a primary synchronization signal (PSS), or any combination thereof. For example, the UE 115 may decode an SSB or acquire an SSS and a PSS for physical broadcast channel (PBCH) decoding. The UE 115 may generate, during the first portion of the DRX cycle or during a third portion of a second DRX cycle (e.g., an on duration of the second DRX cycle), a second RF script associated with a SIB acquisition. The first and second RF scripts may be or may include code or software that may configure one or more RF components of the UE 115 with an RF configuration to receive the synchronization signal and the SIB, respectively.

In some examples, to perform the CGI measurement in response to the control message, the UE 115 may generate a first RF script during a first portion of a first DRX cycle (e.g., an off duration of the DRX cycle) and acquire a synchronization signal during the first portion of the first DRX cycle at the target frequency based on the first RF script. The UE 115 may subsequently generate a second RF script during a second portion of a second DRX cycle (e.g., an off duration of the second DRX cycle) based on information included in the synchronization signal. The UE 115 may acquire a SIB during the second portion of the second DRX cycle based on the second RF script. The UE 115 may thereby perform the CGI measurement across one or more DRX on or off durations to reduce latency, reduce power consumption, and improve a reliability of the CGI measurement.

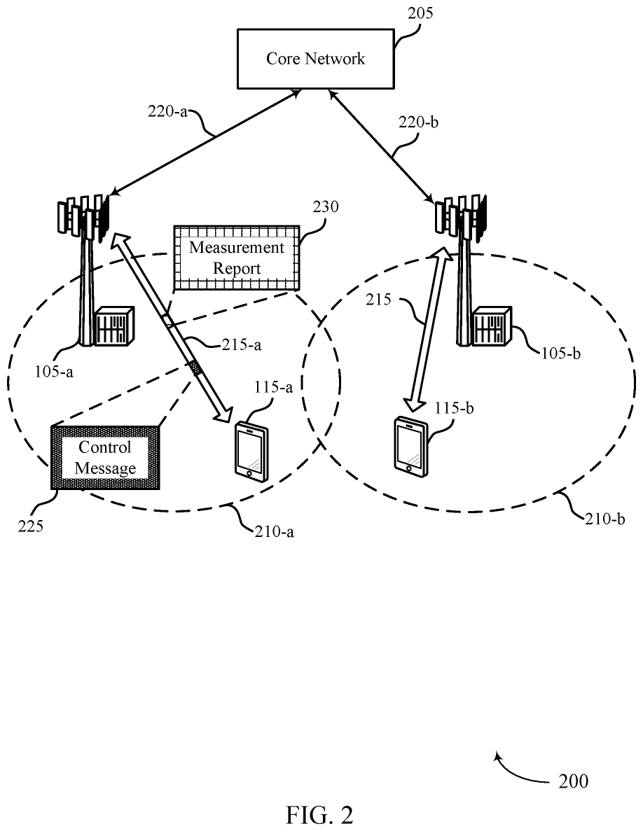

FIG. 2 illustrates an example of a wireless communications system 200 that supports CGI reporting timeline for wireless communications in accordance with aspects of the present disclosure. The wireless communications system 200 may implement or be implemented by aspects of the wireless communications system 100. For example, the wireless communications system 200 may include a core network 205, which may represent an example of a core network 130 as described with reference to FIG. 1. The wireless communications system 200 may additionally include one or more base stations 105 (e.g., a base station 105-a and a base station 105-b, among other base stations 105) and one or more UEs 115 (e.g., a UE 115-a and a UE 115-b, among other UEs 115), which may represent examples of a base station 105 and a UE 115 as described with reference to FIG. 1. In some examples, the UEs 115 may support CGI measurements across multiple DRX on durations, DRX off durations, or both.

The core network 205 may communicate with one or more network nodes, such as base stations 105, via wired or wireless backhaul links 220, which may represent examples of backhaul links 120, as described with reference to FIG. 1. For example, the core network 205 may communicate with the base station 105-a via a backhaul link 220-a and with the base station 105-b via a backhaul link 220-b (e.g., among other base stations 105). In some examples, the base stations 105-a and 105-b may communicate with each other via a respective backhaul link 220 (not pictured in FIG. 2). Each base station 105 may support a serving cell 210. The base station 105-a may support the serving cell 210-a and the base station 105-b may support the serving cell 210-b. The base stations 105 may communicate with one or more UEs 115 or other wireless devices within a corresponding serving cell 210 via a wireless communication link 215.

Each UE 115 may communicate with one or more serving cells 210. For example, the UE 115-a may communicate with the serving base station 105-a in the serving cell 210-a and the UE 115-b may communicate with the serving base station 105-b in the serving cell 210-b. In some examples, the UE 115-a, the UE 115-b, or both may communicate with one or more other base stations 105 and corresponding serving cells 210. The UEs 115-a and 115-b may operate in a connected mode during communication with the respective one or more base stations 105.

A UE 115 that is in a connected mode may measure a PCI of each cell in communication with the UE 115. The UE 115 may send a measurement report 230 to a base station 105 in communication with the UE 115 on a corresponding frequency to indicate the one or more PCIs to the base station 105. In some examples, the base station 105 may receive an indication of a PCI from a UE 115 that is unknown or unexpected, or the base station 105 may identify an issue with a reported PCI. For example, a PCI may not be unique, such that the base station 105 may receive an indication of two or more serving cells 210 that have a same PCI and may be unable to differentiate the serving cells 210. Additionally or alternatively, the base station 105 may receive an indication of a new PCI that the base station 105 was not previously aware of, the base station 105 may receive an ambiguous PCI report, the base station 105 may receive an indication of a PCI that is different than what the base station 105 was expecting, or any combination thereof. In such cases, the base station 105 may request more information from the UE 115 to identify the serving cell 210.

The base station 105 may transmit a control message 225 to request more information from the UE 115 that reported the PCI. The control message 225 may include a request for the UE 115 to perform a CGI measurement (e.g., an inter-frequency NR CGI measurement) for the serving cell 210 associated with the reported PCI. A CGI may be a unique identifier (ID) for the serving cell 210. The CGI may include a public land mobile network (PLMN) ID and a cell ID for a given PCI, which may provide for the base station 105 to identify the serving cell 210. The control message 225 may be an RRC reconfiguration message, or some other control message that may indicate a target frequency and a PCI associated with the CGI measurement. In some examples, the target frequency may be the same as a frequency on which the UE 115 previously reported the PCI. The base station 105 may transmit the control message 225 directly to the UE 115 or may relay the control message 225 to the UE 115 via a serving base station 105. For example, if the UE 115-a reports an unexpected PCI to the base station 105-a, the base station 105-a may transmit the control message 225 to the UE 115-a via the communication link 215-a between the UE 115-a and the base station 105-a to request the CGI measurement.

The UEs 115-a and 115-b of the wireless communications system 200 may support DRX communication, in which the UEs 115 may periodically transition between multiple DRX cycles. Each DRX cycle may include an on duration, in which a UE 115 may transmit and receive data or other communications, and an off duration, in which the UE 115 may enter an idle or off state to reduce power consumption. Some DRX cycles may additionally include an inactivity duration based on a configured inactivity timer. In some examples, a UE 115 may receive an RRC configuration message that establishes a connection between the UE 115 and the base station 105 and indicates a configuration of the multiple DRX cycles (e.g., a DRX periodicity). In such cases, the DRX communications may be referred to as connected DRX (CDRX).

The base station 105 may transmit the control message 225 including the CGI measurement request to the UE 115 during a DRX on duration. In some cases, the UE 115 may perform the CGI measurement during a DRX off duration and the UE 115 may continue to transmit and receive data and other signals during the DRX on durations to support increased throughput (e.g., to reduce a throughput impact of the CGI measurement). The control message 225 that indicates the CGI request may additionally indicate a CGI timer configuration for the UE 115 (e.g., a T321 timer configuration). The timer configuration may indicate a time period (e.g., a maximum time) during which the UE 115 can perform the CGI measurement. In some examples, the time period may correspond to a quantity of one or more DRX cycles, or some other duration.

The UE 115 may attempt to perform the CGI measurement during each DRX off duration until the CGI measurement succeeds or the timer configuration expires, at which point the UE 115 may transmit a measurement report 230. If the CGI measurement does not succeed within the configured time period, the UE 115 will stop a CGI measurement and transmit the measurement report 230 to a serving base station 105 to indicate results of the CGI measurement after the timer expires. The measurement report 230 may indicate a CGI for the serving cell 210 if the CGI measurement is successful, or the measurement report 230 may be empty if the CGI measurement fails.

The UE 115 may perform one or more procedures to identify a CGI for a serving cell 210. For example, to perform the CGI measurement, the UE 115 may generate, or build, a first RF script based on a target frequency indicated via the CGI request message. The first RF script may be or include software or code that may program one or more RF components of the UE 115 with a corresponding RF configuration (e.g., a frequency, bandwidth, or the like) to receive a synchronization signal (e.g., a SSB, a SSS, a PSS, or any combination thereof) at the target frequency. The UE 115 may acquire the synchronization signal at the target frequency based on the first RF script. The UE 115 may generate, or build, a second RF script based on a second frequency indicated via the synchronization signal. The second RF script may be or include code or other software that may program the one or more RF components of the UE 115 with a second RF configuration to receive a SIB (e.g., SIB-1) at the second frequency. The UE 115 may acquire the SIB based on the second RF script. The SIB may include a CGI for the corresponding serving cell 210. The UE 115 may transmit a measurement report 230 to indicate the CGI measurement based on successfully acquiring the SIB.

A duration of the CGI measurement (e.g., a total duration associated with the generation of the first and second RF scripts, generation of corresponding first and second channel configurations, and acquisition of the synchronization signal and SIB) may, in some cases, be greater than a duration of one or more DRX off durations. As such, attempts to perform the CGI measurement in one or more DRX off durations may fail. In some cases, the UE 115 may attempt the CGI measurement multiple times before the UE 115 successfully obtains the CGI, which may increase latency associated with the CGI report. Alternatively, the UE 115 may be unable to perform the CGI measurement successfully before the configured CGI timer expires, and the UE 115 may transmit an empty measurement report 230 to the base station 105. Some techniques for performing a CGI measurement in a DRX off duration may thereby be associated with increased latency, increased, power consumption, and reduced reliability.

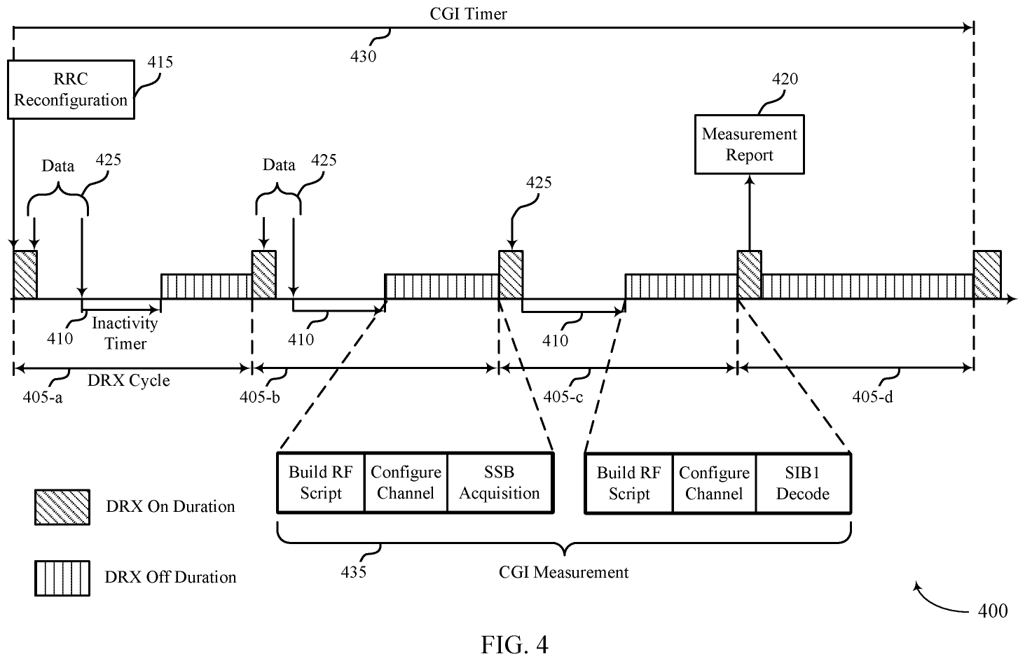

Techniques described herein provide for a UE 115 to divide a CGI measurement into two or more portions, or tasks, and perform the two or more portions in different DRX on durations, DRX off durations, or both. For example, the UE 115 may generate the first and second RF scripts during one or more DRX on durations to reduce latency, and the UE 115 may perform the synchronization signal acquisition and the SIB acquisition during one or more DRX off durations. Additionally or alternatively, the UE 115 may be configured to perform a first portion of the CGI measurement during a first DRX off duration and a second portion of the CGI measurement during a second DRX off duration. A duration of each of the first and second portions may be less than the DRX off durations, which may provide for a higher likelihood of the CGI measurement succeeding. The UE 115 may transmit the measurement report 230 to the base station 105 to indicate the CGI faster than if the UE 115 does not divide the CGI measurement into two or more separate tasks. Example configurations and measurement timelines for dividing CGI measurements across DRX cycles are described in further detail herein, including with reference to FIGS. 4 through 7.

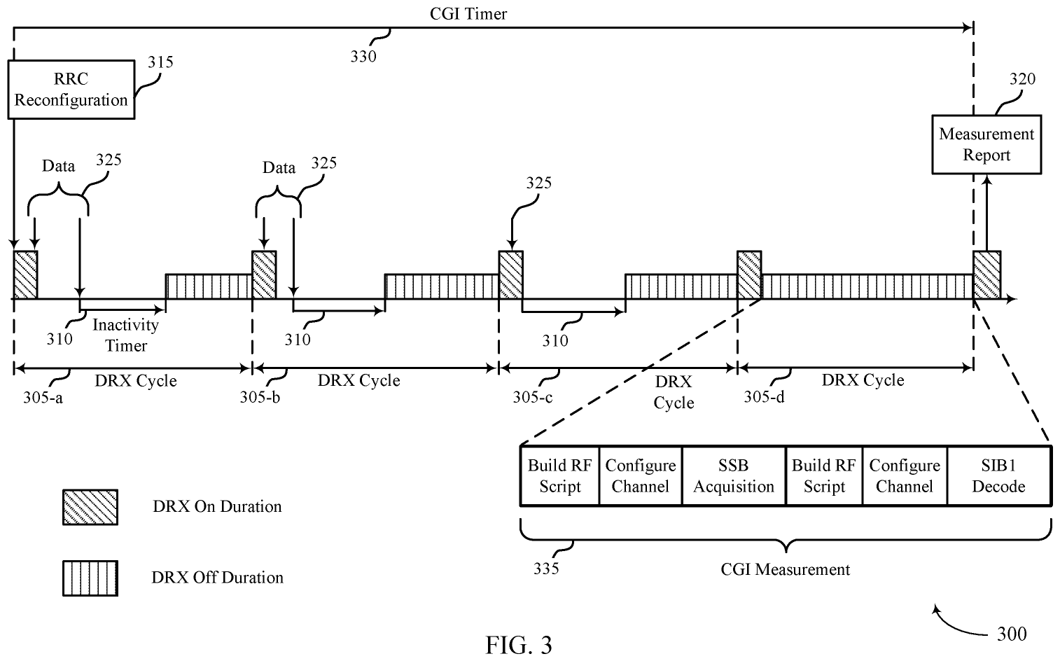

FIG. 3 illustrates an example of a CGI measurement configuration 300 that supports CGI reporting timeline for wireless communications in accordance with aspects of the present disclosure. The CGI measurement configuration 300 may implement or be implemented by aspects of the wireless communications systems 100 and 200. For example, the CGI measurement configuration 300 may illustrate communications between a UE 115 and a base station 105, which may be examples of corresponding devices described with reference to FIGS. 1 and 2. The UE 115 may perform a CGI measurement in response to a CGI measurement request from the network.

The UE 115 may operate in a DRX mode (e.g., a CDRX mode), in which the UE 115 may periodically transition between a set of multiple DRX cycles 305 (e.g., the DRX cycles 305-a, 305-b, 305-c and 305-d, among other DRX cycles 305). Each DRX cycle 305 may include one or more of a DRX on duration, an inactivity duration, and a DRX off duration. The UE 115 may monitor for or transmit data 325 and other signals during a DRX on duration. The UE 115 may enter an idle or sleep mode during a DRX off duration to reduce power consumption. In some examples, a duration or length of each DRX cycle 305 may be the same (e.g., corresponding to a configured DRX periodicity). Each DRX cycle 305 may include a DRX on duration having a same configured length. If the UE 115 does not have data 325 to transmit or receive during the DRX on duration, such as during the DRX on duration of the DRX cycle 305-d, the UE 115 may transition to an off state after the configured length of the DRX on duration.

If the UE 115 does transmit or receive data 325 during a DRX on duration, the UE 115 may, in some examples, extend the on duration or enter an inactivity duration to improve communication. For example, the UE 115 may start an inactivity timer 310 having a configured duration after the UE 115 stops receiving or transmitting data 325. In the example of FIG. 3, the UE 115 may transmit or receive data 325 during the DRX on durations of the DRX cycles 305-a and 305-b, and the UE 115 may identify more data 325 to transmit or receive after the DRX on durations end. The UE 115 may start the inactivity timer 310 after transmitting or receiving the data 325 in each of the DRX cycles 305-a and 305-b. In the example of the DRX cycle 305-c, the UE 115 may receive some data 325 during the DRX on duration, and the UE 115 may not identify additional data after the DRX on duration. The UE 115 may start the inactivity timer 310 after the DRX on duration ends.

If the inactivity timer 310 expires before the UE 115 identifies more data 325, the UE 115 will transition to a DRX off duration for a remainder of the DRX cycle 305. The DRX off duration may thereby have a variable duration within each DRX cycle 305. For example, a DRX off duration may be relatively short if the UE 115 transmits or receives data for a relatively long time during a single DRX cycle 305. Alternatively, if the UE 115 does not have data to transmit or receive during a DRX cycle 305, such as the DRX cycle 305-d, the UE 115 will refrain from starting an inactivity timer 310 after the DRX on duration, and the DRX off duration may be relatively long.

In the example of FIG. 3, the UE 115 may receive a control message, such as an RRC reconfiguration message 315, during a DRX on duration of a DRX cycle 305-a. The RRC reconfiguration message 315 may indicate a request for the UE 115 to perform a CGI measurement 335 and a configured CGI timer 330 associated with the measurement (e.g., a T321 timer). The CGI timer 330 may correspond to a quantity of DRX cycles 305 or some other time period in which the UE 115 can perform the CGI measurement 335. The RRC reconfiguration message 315 may additionally indicate a target frequency associated with the CGI measurement 335, a PCI associated with the CGI measurement 335, or both. In some cases, the UE 115 may transmit a report indicating a PCI of a cell, and the network may transmit the RRC reconfiguration message 315 in response to or based on the indicated PCI, as described with reference to FIG. 2.

The UE 115 may perform multiple sub-procedures to successfully complete the CGI measurement 335. For example, to perform the CGI measurement 335, the UE 115 may build a first RF script based on the target frequency and a bandwidth indicated via the RRC reconfiguration message 315, configure a channel at the target frequency, acquire an SSB or other synchronization signal based on the first RF script and channel configuration, build a second RF script based on a second frequency indicated in the synchronization signal, configure a second channel at the second frequency, and acquire a SIB (e.g., SIB-1) based on the second RF script and second channel configuration. The SIB may include the CGI for the cell. Each sub-procedure may take time, and the CGI measurement 335 may thereby correspond to a relatively long duration (e.g., 140 ms, or some other duration).

In some cases, such as in the example of FIG. 3, the UE 115 may be configured to perform the CGI measurement 335 during a single DRX off duration. For example, the UE 115 may attempt to perform the CGI measurement 335 in the DRX off duration in each of the DRX cycles 305-a, 305-b, 305-c, and 305-d until the CGI measurement 335 is successful (e.g., the UE 115 obtains the CGI) or the configured CGI timer 330 expires.

In the example of FIG. 3, a duration of the DRX off durations in each of the DRX cycles 305-a, 305-b, and 305-c may be relatively short (e.g., 65 ms, 80 ms, 90 ms, or some other duration) due to the UE 115 transmitting or receiving data 325 and utilizing the inactivity timer 310. A duration of the CGI measurement 335 may be greater than the duration of the DRX off durations in the DRX cycles 305-a, 305-b, and 305-c. The UE 115 may be configured to attempt to perform the CGI measurement 335 during each DRX off duration (e.g., instead of transitioning to an idle or off state), and the CGI measurement 335 may fail in each of the DRX cycles 305-a through 305-c due to the reduced durations. Such techniques for CGI measurement may increase processing, power consumption, and overhead.

The UE 115 may not receive or transmit data 325 during the DRX cycle 305-d and the UE 115 may transition to the DRX off duration after the DRX on duration (e.g., without starting an inactivity timer 310). The DRX off duration of the DRX cycle 305-d may thereby be relatively long (e.g., 140 ms or more). As such, a duration of the CGI measurement 335 may be less than or the same as the duration of the DRX off duration in the DRX cycle 305-d, and the CGI measurement 335 may, in some examples, succeed. The UE 115 may transmit the measurement report 320 to the network to indicate the measured CGI in response to the CGI measurement 335 succeeding. The UE 115 may transmit the measurement report 320 during a DRX on duration of a subsequent DRX cycle 305.

In some examples, the CGI measurement 335 may not succeed during the DRX cycle 305-d, and the CGI timer 330 may expire after the DRX cycle 305-d. The CGI measurement 335 may fail if, for example, the DRX off duration is shorter than a duration of the CGI measurement 335, if the UE 115 fails to accurately build an RF script, if the UE 115 fails to receive or decode the synchronization signal or the SIB, or any combination thereof. In such cases, the UE 115 may transmit the measurement report 320 including an empty CGI measurement report after the CGI timer 330 expires, and the UE 115 may refrain from re-attempting to perform the CGI measurement 335 in subsequent DRX cycles 305.

The CGI measurement configuration 300 may thereby be associated with relatively high latency and power consumption, and relatively low reliability. To improve CGI measurements, techniques described herein provide for the UE 115 to divide the CGI measurement 335 into two or more portions and perform the portions across multiple DRX on durations, DRX off durations, or both. Example configurations for dividing the CGI measurement 335 are described herein with reference to FIGS. 4 through 7.

FIG. 4 illustrates an example of a CGI measurement configuration 400 that supports CGI reporting timeline for wireless communications in accordance with aspects of the present disclosure. The CGI measurement configuration 400 may implement or be implemented by aspects of the wireless communications systems 100 and 200. For example, the CGI measurement configuration 400 may illustrate communications between a UE 115 and a base station 105, which may be examples of corresponding devices described with reference to FIGS. 1 through 3. The UE 115 may be configured to divide a CGI measurement 435 into two or more portions to improve CGI reporting.

The UE 115 may operate in a DRX mode (e.g., a CDRX mode), in which the UE 115 may periodically transition between a set of multiple DRX cycles 405 (e.g., the DRX cycles 405-a, 405-b, 405-c and 405-d, among other DRX cycles 405). Each DRX cycle 405 may include one or more of a DRX on duration, an inactivity duration (e.g., based on an inactivity timer 410), and a DRX off duration. As described with reference to FIG. 3, a length of each DRX cycle 405 may be the same and a length of a DRX off duration in each DRX cycle 405 may be variable (e.g., based on an amount of data 425 transmitted or received by the UE 115 during the DRX cycle 405 and an inactivity timer 410).

The UE 115 may receive a control message, such as the RRC reconfiguration message 415, during a DRX on duration of the DRX cycle 405-a. The RRC reconfiguration message 415 may indicate a request for the UE 115 to perform a CGI measurement 435 for a given cell on a target frequency. The RRC reconfiguration message 415 may indicate the CGI measurement request, the target frequency, a PCI associated with the cell, a CGI timer 430, or any combination thereof. The CGI timer 430 may correspond to a configured duration within which the UE 115 can perform the CGI measurement 435.

In some cases, the UE 115 may attempt to perform the CGI measurement 435 during each DRX off duration until the CGI measurement 435 succeeds or the CGI timer 430 expires. However, a duration of the CGI measurement 435 may be greater than a duration of one or more DRX off durations, such that the UE 115 may attempt to perform the CGI measurement 435 during multiple DRX off durations before succeeding, or the UE 115 may not successfully perform the CGI measurement 435 before the CGI timer 430 expires. Such CGI measurement techniques may provide for relatively high processing and power consumption, increased latency, and reduced reliability.

Techniques described herein provide for the UE 115 to divide the CGI measurement 435 into two or more portions to reduce power consumption, reduce latency, and improve a reliability of the CGI measurement 435. In the example of FIG. 4, the UE 115 may be configured to perform a first portion of the CGI measurement 435 during a DRX off duration of the DRX cycle 405-b and a second portion of the CGI measurement 435 during a DRX off duration of the DRX cycle 405-c. A duration of each portion of the CGI measurement 435 may be less than a duration of the corresponding DRX off duration, which may improve a probability that the CGI measurement 435 will succeed (e.g., with fewer re-attempts).

The first portion of the CGI measurement 435 may include a generation of a first RF script based on the target frequency indicated via the RRC reconfiguration message 415, a configuration of a first channel associated with a synchronization signal at the target frequency, and acquisition of the synchronization signal at the target frequency based on the first RF script and the first channel configuration. The UE 115 may attempt to perform the first portion of the CGI measurement 435 during the DRX off duration of the DRX cycle 405-a. In some examples (not pictured in FIG. 4), the UE 115 may successfully acquire the synchronization signal during the DRX cycle 405-a. Alternatively, in some examples, the UE 115 may not successfully acquire the synchronization signal. For example, a duration of the first portion of the CGI measurement 435 (e.g., 70 ms, or some other duration) may be greater than a duration of the DRX off duration of the DRX cycle 405-a (e.g., 65 ms, or some other duration), such that the first portion may fail during the DRX cycle 405-a.

The UE 115 may re-attempt to acquire the synchronization signal and successfully perform the first portion of the CGI measurement 435 during the DRX off duration of the DRX cycle 405-b. In some examples, the DRX off duration may be referred to as a portion of the DRX cycle 405-b. The synchronization signal may be an SSB, an SSS, a PSS, or any combination thereof that may convey system information for the UE 115, such as PBCH information. The UE 115 may store one or more parameters associated with the synchronization signal (e.g., a time, an SFN, a frequency, or any combination thereof associated with the synchronization signal), the PBCH information, or both at the UE 115. The PBCH information may indicate second frequency associated with a SIB (e.g., SIB-1) for the UE 115. The UE 115 may store the second frequency in a measurement database of the UE 115 and maintain the stored second frequency during a DRX on duration of the DRX cycle 405-c. The UE 115 may receive or transmit data 425 during the DRX on duration of the DRX cycle 405-c. The UE 115 may subsequently transition to the DRX off duration of the DRX cycle 405-c in response to an expiration of the inactivity timer 410.

The UE 115 may perform the second portion of the CGI measurement 435 during the DRX off duration of the DRX cycle 405-c based on the stored PBCH information. The second portion of the CGI measurement 435 may include generation of a second RF script based on the second frequency indicated via the synchronization signal, configuration of a channel at the second frequency, and acquisition of a SIB at the second frequency based on the second RF script and the second channel configuration. The UE 115 may decode the SIB based on the stored synchronization signal and PBCH information. The SIB may include the CGI for the cell. In the example of FIG. 4, a duration of the second portion of the CGI measurement 435 (e.g., 70 ms, or some other duration) may be less than or the same as a duration of the DRX off duration of the DRX cycle 405-c (e.g., 90 ms, or some other duration), and the second portion may succeed. That is, the UE 115 may successfully acquire the SIB. If the second portion of the measurement fails, the UE 115 may re-attempt the second portion of the measurement in the DRX off duration of the DRX cycle 405-d based on the stored second frequency. In some examples, the UE 115 may delete the second frequency from the measurement database based on or in response to successfully acquiring the SIB.

Although two portions of the CGI measurement 435 are illustrated in FIG. 4, it is to be understood that the UE 115 may be configured to divide the CGI measurement 435 into any quantity of portions that each include any combination of one or more procedures or tasks involved in obtaining a CGI measurement. For example, the first and second portions may include any quantity of the CGI measurement tasks that may provide for reduced latency and improved reliability of the CGI measurement 435.

The UE 115 may transmit the measurement report 420 in response to successfully acquiring the SIB including the CGI. The UE 115 may transmit the measurement report 420 during the DRX on duration of the DRX cycle 405-d (e.g., a portion of a DRX cycle 405 subsequent to the DRX cycle 405 in which the CGI is obtained). The measurement report 420 may indicate the CGI for the cell. The UE 115 may thereby obtain the CGI and transmit the measurement report 420 faster if the UE 115 divides the CGI measurement 435 into two or more portions than if the UE 115 attempts to perform the CGI measurement 435 in a single DRX off duration (e.g., as described with reference to FIG. 3).

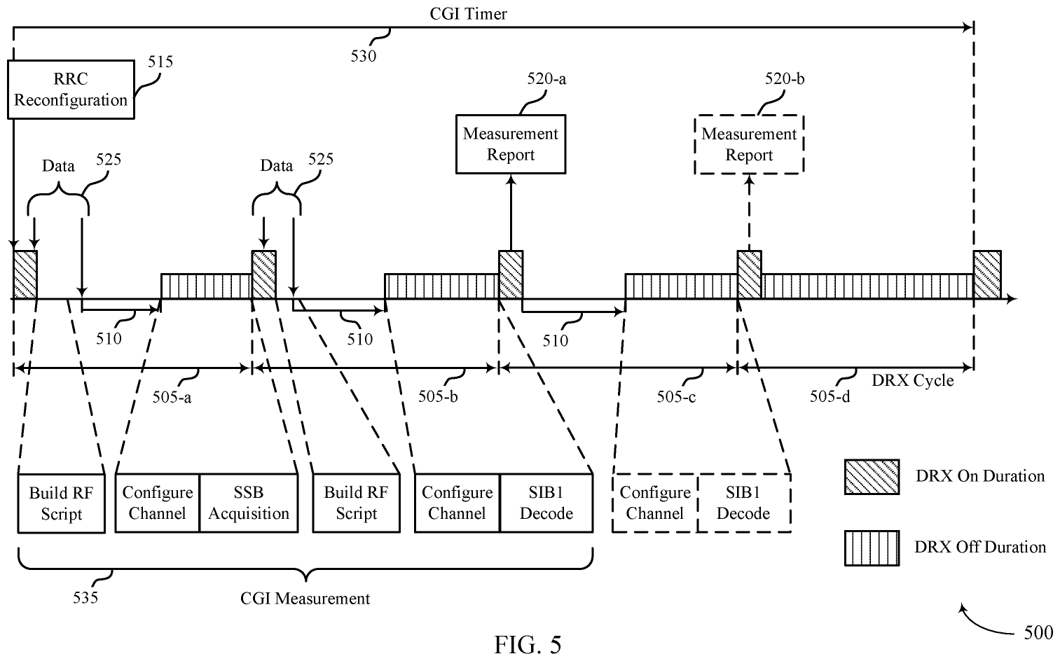

FIG. 5 illustrates an example of a CGI measurement configuration 500 that supports CGI reporting timeline for wireless communications in accordance with aspects of the present disclosure. The CGI measurement configuration 500 may implement or be implemented by aspects of the wireless communications systems 100 and 200. For example, the CGI measurement configuration 500 may illustrate communications between a UE 115 and a base station 105, which may be examples of corresponding devices described with reference to FIGS. 1 through 4. The UE 115 may be configured to perform a CGI measurement 535 during one or more DRX on and off durations to improve CGI reporting techniques.

The UE 115 may operate in a DRX mode (e.g., a CDRX mode), in which the UE 115 may periodically transition between a set of multiple DRX cycles 505 (e.g., the DRX cycles 505-a, 505-b, 505-c and 505-d, among other DRX cycles 505). Each DRX cycle 505 may include one or more of a DRX on duration, an inactivity duration (e.g., based on an inactivity timer 510), and a DRX off duration. As described with reference to FIG. 3, a length of each DRX cycle 505 may be the same and a length of a DRX off duration in each DRX cycle 505 may vary based on an inactivity timer 510 and an amount of data 525 transmitted or received by the UE 115 during the respective DRX cycle 505.

The UE 115 may receive a control message, such as the RRC reconfiguration message 515, during a DRX on duration of the DRX cycle 505-a. The RRC reconfiguration message 515 may indicate a request for the UE 115 to perform a CGI measurement 535 for a given cell on a target frequency. The RRC reconfiguration message 515 may indicate the CGI measurement request, the target frequency, a PCI associated with the cell, a CGI timer 530, or any combination thereof. The CGI timer 530 may correspond to a configured duration within which the UE 115 can perform the CGI measurement 535.

In some cases, the UE 115 may attempt to perform the CGI measurement 535 during each DRX off duration until the CGI measurement 535 succeeds or the CGI timer 530 expires. However, a duration of the CGI measurement 535 may be greater than a duration of one or more DRX off durations, such that the UE 115 may attempt to perform the CGI measurement 535 during multiple DRX off durations before succeeding, or the UE 115 may not successfully perform the CGI measurement 535 before the CGI timer 530 expires. Such CGI measurement techniques may provide for relatively high processing and power consumption, increased latency, and reduced reliability.

Techniques described herein provide for the UE 115 to divide the CGI measurement 535 into two or more portions and perform the portions within different DRX on and off durations to reduce power consumption, reduce latency, and improve a reliability of the CGI measurement 535. In the example of FIG. 5, the UE 115 may be configured to pre-build or pre-generate an RF script during a DRX on duration, an inactivity duration, or both. For example, the UE 115 may build a first RF script for acquisition of a synchronization signal during a first portion of the DRX cycle 505-a. The first portion of the DRX cycle 505-a may include some or all of the DRX on duration, the inactivity duration associated with the inactivity timer 510, or both.

The UE 115 may build the first RF script for the synchronization signal acquisition based on the target frequency indicated via the RRC reconfiguration message 515 and a configured bandwidth for the synchronization signal. For example, an SSB bandwidth may be defined as a quantity of PRBs for each subcarrier spacing (SCS) value (e.g., 20 PRBs, or 7.2 MHz at a 30 kHz SCS, or some other bandwidth). To build the first RF script, the UE 115 may generate software or code that configures RF components of the UE 115 with a first radio configuration to receive the synchronization signal at the target frequency. The UE 115 may continue to receive and transmit data 525 during the DRX on duration while generating the first RF script, which may improve throughput and reduce latency associated with the CGI measurement 535 as compared with techniques in which the UE 115 generates the RF script during a DRX off duration.

The UE 115 may store the first RF script at the UE 115 (e.g., in a measurement database) until the UE 115 successfully acquires the synchronization signal associated with the first RF script. The UE 115 may transition to the DRX off duration of the DRX cycle 505-a. The UE 115 may perform at least a portion of the CGI measurement 535 during the DRX off duration of the DRX cycle 505-a. For example, the UE 115 may configure a channel at the target frequency and acquire the SSB or other synchronization signal at the target frequency based on the first RF script. A duration of the channel configuration and synchronization signal acquisition may be less than a duration of the DRX off duration of the DRX cycle 505-a, such that the UE 115 may successfully acquire the SSB.

In some examples (not pictured in FIG. 5), the synchronization signal acquisition may fail during the DRX cycle 505-a (e.g., due to interference, a reduced DRX off duration, or both), and the UE 115 may re-configure the channel and re-attempt to acquire the SSB in a subsequent DRX off duration, such as the DRX off duration of the DRX cycle 505-b. The UE 115 may re-configure the channel based on the stored first RF script. The UE 115 may store the first RF script until a success of the first portion of the CGI measurement 535. The UE 115 may delete the first RF script in response to successfully acquiring the synchronization signal to save memory space and improve storage. Additionally or alternatively, the UE 115 may store the first RF script until the CGI measurement 535 is complete or the UE 115 may indefinitely store the first RF script.

The synchronization signal may include system information (e.g., PBCH information) for the UE 115. The UE 115 may decode the synchronization signal and store the system information and one or more other parameters associated with the synchronization signal in the measurement database of the UE 115. The system information may indicate a second frequency associated with a SIB (e.g., SIB-1), a bandwidth of the SIB, or both. The UE 115 may generate a second RF script based on the system information in a DRX on duration, an inactivity duration, or both after successfully acquiring the synchronization signal. In the example of FIG. 5, the UE 115 may generate the second RF script during the DRX on duration and the inactivity duration (e.g., associated with the inactivity timer 510) of the DRX cycle 505-b. In some examples, the DRX on duration and corresponding inactivity duration may be referred to as a portion of the DRX cycle 505-b, and the DRX off duration may be referred to as a different portion of the DRX cycle 505-b. The UE 115 may generate the software or code associated with the second RF script while continuing to transmit or receive the data 525.

The UE 115 may perform a second portion of the CGI measurement 535 during a subsequent DRX off duration based on the second RF script. In the example of FIG. 5, the UE 115 may perform the second portion of the CGI measurement 535 during the DRX off duration of the DRX cycle 505-b. The second portion of the CGI measurement 535 may include configuring a second channel and acquiring the SIB. The SIB may include the CGI for the cell. The UE 115 may configure the second channel and acquire the SIB at the second frequency based on the second RF script, the second frequency, and the bandwidth indicated via the synchronization signal. In some examples, a duration of the channel configuration and SIB acquisition (e.g., 60 ms, or some other duration) may be less than or the same as a duration of the DRX off duration of the DRX cycle 505-b, and the UE 115 may successfully acquire the SIB during the DRX cycle 505-b. In such cases, the UE 115 may transmit the measurement report 520-a in a DRX on duration of the next DRX cycle 505-c to indicate the CGI for the cell.

In some examples, the second portion of the CGI measurement 535 may fail. That is, the UE 115 may not receive or decode the SIB during the DRX cycle 505-b. The UE 115 may re-attempt the second portion of the CGI measurement 535 during a subsequent DRX cycle 505-c. The UE 115 may configure the channel and acquire the SIB based on the second RF script generated during the DRX cycle 505-b. The UE 115 may store the second RF script until the SIB is successfully acquired. If the UE 115 successfully receives and decodes the SIB in the DRX cycle 505-c, the UE 115 will delete the second RF script to save memory space. The UE 115 may transmit the measurement report 520-b during the DRX on duration of the next DRX cycle 505-d based on successfully acquiring the SIB.

The UE 115 may thereby be configured to pre-build one or more RF scripts during a DRX on duration to reduce power consumption and reduce latency associated with a CGI measurement 535. The UE 115 may divide the remaining CGI measurement 535 into one or more portions and perform each portion in a corresponding DRX off duration to further improve reliability and reduce latency of the CGI measurement 535. The UE 115 may report a CGI measurement faster and with reduced power consumption using the described techniques than if the UE 115 performs the CGI measurement 535 in a single DRX off duration.

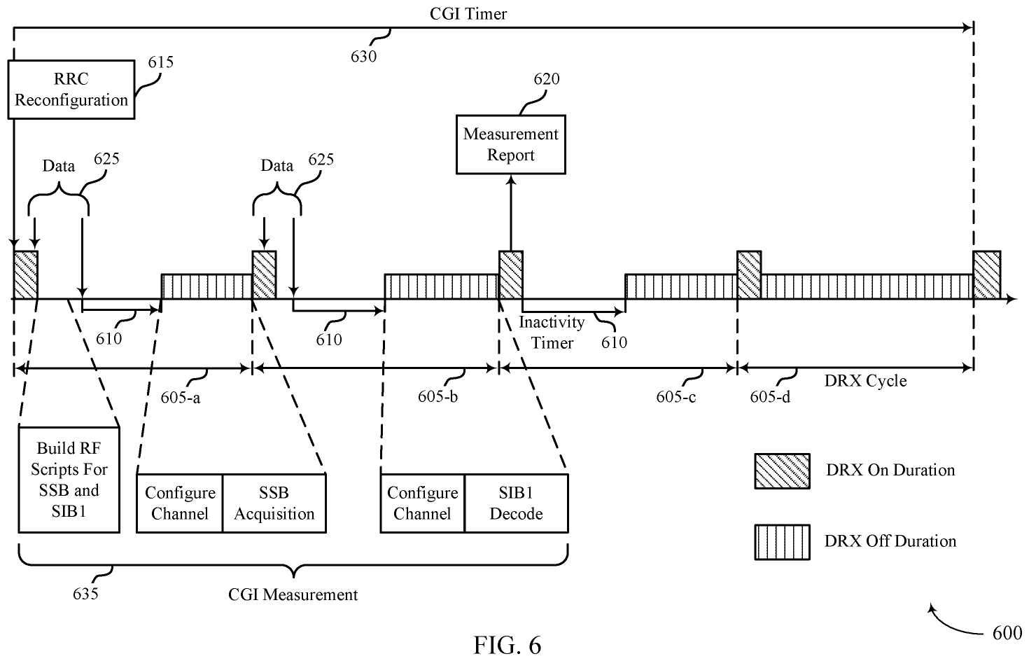

FIG. 6 illustrates an example of a CGI measurement configuration 600 that supports CGI reporting timeline for wireless communications in accordance with aspects of the present disclosure. The CGI measurement configuration 600 may implement or be implemented by aspects of the wireless communications systems 100 and 200. For example, the CGI measurement configuration 600 may illustrate communications between a UE 115 and a base station 105, which may be examples of corresponding devices described with reference to FIGS. 1 through 5. The UE 115 may be configured to perform a CGI measurement 535 during one or more DRX on and off durations to improve CGI reporting techniques.

The UE 115 may operate in a DRX mode (e.g., a CDRX mode), in which the UE 115 may periodically transition between a set of multiple DRX cycles 605 (e.g., the DRX cycles 605-a, 605-b, 605-c and 605-d, among other DRX cycles 605). Each DRX cycle 605 may include one or more of a DRX on duration, an inactivity duration associated with an inactivity timer 610, and a DRX off duration. As described with reference to FIG. 3, a length, or duration of each DRX cycle 605 may be the same and a length of a DRX off duration in each DRX cycle 605 may vary based on an inactivity timer 610 and an amount of data 625 transmitted or received by the UE 115 during the respective DRX cycle 605.

The UE 115 may receive a control message, such as an RRC reconfiguration message 615, during a DRX on duration of the DRX cycle 605-a. The RRC reconfiguration message 615 may indicate a request for the UE 115 to perform a CGI measurement 635 for a given cell on a target frequency. The RRC reconfiguration message 615 may indicate the CGI measurement request, the target frequency, a PCI associated with the cell, a CGI timer 630, or any combination thereof. The CGI timer 630 may correspond to a configured duration within which the UE 115 can perform the CGI measurement 635.

In some cases, the UE 115 may attempt to perform the CGI measurement 635 during each DRX off duration until the CGI measurement 635 succeeds or the CGI timer 630 expires. However, a duration of the CGI measurement 635 may be greater than a duration of one or more DRX off durations, such that the UE 115 may attempt to perform the CGI measurement 635 during multiple DRX off durations before succeeding, or the UE 115 may not successfully perform the CGI measurement 635 before the CGI timer 630 expires. Such CGI measurement techniques may provide for relatively high processing and power consumption, increased latency, and reduced reliability.

Techniques described herein provide for the UE 115 to divide the CGI measurement 635 into two or more portions and perform the portions within different DRX on and off durations to reduce power consumption, reduce latency, and improve a reliability of the CGI measurement 635. In the example of FIG. 6, the UE 115 may be configured to pre-build or pre-generate both the first and second RF scripts for the CGI measurement 635 during a same DRX on duration after receiving the RRC reconfiguration message 615 to reduce latency of the CGI measurement. For example, the UE 115 may pre-build a first RF script for acquisition of a synchronization signal and a second RF script for acquisition of a SIB during a DRX on duration, an inactivity duration, or both, of the DRX cycle 605-a. In some examples, the DRX on duration and the inactivity duration (e.g., associated with the inactivity timer 610) may be referred to as a portion of the DRX cycle 605-a, and the DRX off duration may be referred to as a different portion of the DRX cycle 605-a. The UE 115 may store the pre-built first RF script and the pre-built second RF script at the UE 115 (e.g., in a database of the UE 115).

The UE 115 may pre-build the first RF script for the synchronization signal acquisition based on the target frequency indicated via the RRC reconfiguration message 615 and a configured bandwidth for the synchronization signal. For example, an SSB bandwidth may be defined as a quantity of PRBs for each SCS value (e.g., 20 PRBs, or 7.2 MHz at a 30 kHz SCS, or some other bandwidth). To build the first RF script, the UE 115 may generate software or code that configures RF components of the UE 115 with a first configuration to receive the synchronization signal at the target frequency.

The UE 115 may pre-build the second RF script prior to receiving the synchronization signal based on previous measurements associated with the target frequency or camping on the target frequency, which may be referred to as fingerprinting. The UE 115 may have previously measured a PCI for the cell and reported the measured PCI to the network. The network may transmit the RRC reconfiguration message 615 requesting the UE 115 to perform a CGI measurement for the cell based on receiving the PCI measurement report, as described with reference to FIG. 2. To perform the PCI measurement, the UE 115 may acquire a synchronization signal (e.g., an SSB) on the target frequency. The synchronization signal may include system information, such as PBCH information, which may indicate a second frequency and bandwidth associated with a SIB. The UE 115 may store an indication of the target frequency and the PBCH information associated with the target frequency, such as the second frequency and the bandwidth of the SIB.

The UE 115 may thereby pre-build the second RF script for SIB acquisition during the DRX on duration of the DRX cycle 605-a based on the stored second frequency and the stored bandwidth from a previous camping attempt on the target frequency (e.g., previous SSB or PCI measurements). In some examples, the UE 115 may utilize frequency-based fingerprinting (e.g., the fingerprinting may be applicable to intra-frequency CGI measurements 635), in which the UE 115 may identify PBCH information obtained at the same frequency as the target frequency for the CGI measurement 635. A single frequency may, in some cases, be associated with multiple cells and corresponding PCIs. In some examples, the UE 115 may utilize a SIB frequency and bandwidth associated with a primary cell (PCell). The UE 115 may additionally or alternatively perform fingerprinting using previous measurements associated with the same frequency as the target frequency for the CGI measurement 635 and the same PCI as the target PCI for the CGI measurement 635.

The UE 115 may continue to receive and transmit data 625 during the DRX on duration of the DRX cycle 605-a while generating the first RF script and the second RF script, which may improve throughput and reduce latency associated with the CGI measurement 635 as compared with techniques in which the UE 115 generates the RF script during a DRX off duration. The UE 115 may store the first and second RF scripts at the UE 115 (e.g., in a measurement database) until the UE 115 successfully acquires the synchronization signal associated with the first RF script or the SIB associated with the second RF script, respectively.

The UE 115 may transition to the DRX off duration of the DRX cycle 605-a after generating the RF scripts and after an expiration of the inactivity timer 610. The UE 115 may perform the SSB acquisition and the SIB acquisition during one or more subsequent DRX off durations. In the example of FIG. 6, the UE 115 may configure a first channel and acquire the synchronization signal at the target frequency during the DRX off duration of the DRX cycle 605-a based on the first RF script for the synchronization signal acquisition. The UE 115 may configure a second channel and acquire the SIB at the second frequency during a subsequent DRX off duration of the DRX cycle 605-b based on the second RF script. A duration of each of the synchronization signal and SIB acquisitions may be less than or the same as a duration of the respective DRX off durations, such that the UE 115 may successfully acquire and decode the corresponding signals.

The UE 115 may transmit a measurement report 620 to the network based on successfully acquiring the SIB including the CGI for the cell. The measurement report 620 may indicate the CGI. The UE 115 may transmit the measurement report 620 during a DRX on duration of the DRX cycle 605-c that is subsequent to the DRX cycle 605-b in which the UE 115 acquired the SIB. The UE 115 may, in some examples, delete the first RF script and the second RF script to save memory space based on successfully acquiring the synchronization signal and the SIB, respectively, or based on a success of the CGI measurement 635.

In some examples (not pictured in FIG. 6), the UE 115 may acquire the synchronization signal and the SIB in a same DRX off duration of a same DRX cycle 605 based on the first and second RF scripts. For example, if a duration of the synchronization signal and SIB acquisitions is less than or the same as a duration of the DRX off duration of the DRX cycle 605-a, the UE 115 may acquire both signals during the DRX off duration of the DRX cycle 605-a. In such cases, the UE 115 may transmit the measurement report 620 during the DRX on duration of the DRX cycle 605-b.

The UE 115 may thereby pre-build a first RF script for a synchronization signal acquisition and a second RF script for a SIB acquisition in a same DRX on duration, which may reduce latency and reduce power consumption associated with a CGI measurement 635. The UE 115 may store the RF scripts and perform the remainder of the CGI measurement 635 in one or more DRX off durations based on the stored RF scripts to improve reliability of the CGI measurement 635.

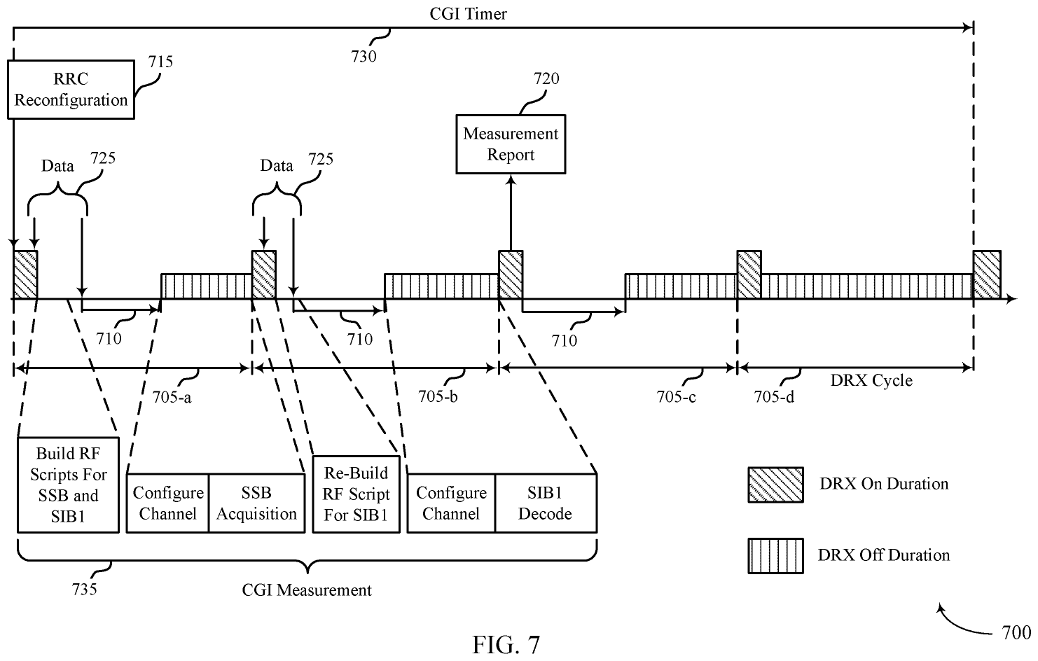

FIG. 7 illustrates an example of a CGI measurement configuration 700 that supports CGI reporting timeline for wireless communications in accordance with aspects of the present disclosure. The CGI measurement configuration 700 may implement or be implemented by aspects of the wireless communications systems 100 and 200. For example, the CGI measurement configuration 700 may illustrate communications between a UE 115 and a base station 105, which may be examples of corresponding devices described with reference to FIGS. 1 through 6. The UE 115 may be configured to perform a CGI measurement 735 during one or more DRX on and off durations to improve CGI reporting techniques.

The UE 115 may operate in a DRX mode (e.g., a CDRX mode), in which the UE 115 may periodically transition between a set of multiple DRX cycles 705 (e.g., the DRX cycles 705-a, 705-b, 705-c and 705-d, among other DRX cycles 705). Each DRX cycle 705 may include one or more of a DRX on duration, an inactivity duration associated with an inactivity timer 710, and a DRX off duration, as described with reference to FIGS. 3 through 6. The UE 115 may communicate data 725 or other signals during the DRX on durations.

The CGI measurement configuration 700 may represent an example of the CGI measurement configuration 600. For example, the UE 115 may receive a control message, such as an RRC reconfiguration message 715, during a DRX on duration of the DRX cycle 705-a. The RRC reconfiguration message 715 may indicate a request for the UE 115 to perform a CGI measurement 735 for a given cell on a target frequency. The RRC reconfiguration message 715 may indicate the CGI measurement request, the target frequency, a PCI associated with the cell, a CGI timer 730, or any combination thereof. The CGI timer 730 may correspond to a configured duration within which the UE 115 can perform the CGI measurement 735.

The UE 115 may be configured to pre-build or pre-generate both the first and second RF scripts for the CGI measurement 735 during a same DRX on duration, and the UE 115 may store the pre-built first and second RF scripts to use for performing remaining portions of the CGI measurement 735. For example, the UE 115 may pre-build a first RF script for acquisition of a synchronization signal and a second RF script for acquisition of a SIB during a DRX on duration, an inactivity duration, or both, of the DRX cycle 705-a. In some examples, the DRX on duration and the inactivity duration may be referred to as a portion of the DRX cycle 705-a, and the DRX off duration may be referred to as a different portion of the DRX cycle 705-a.

The UE 115 may pre-build the first RF script for the synchronization signal acquisition based on the target frequency indicated via the RRC reconfiguration message 715 and a configured bandwidth for the synchronization signal. The UE 115 may pre-build the second RF script for the SIB acquisition based on a second frequency and a second bandwidth of a SIB determined from previous measurements associated with the target frequency, which may be referred to as fingerprinting, as described with reference to FIG. 6.

As described herein, the UE 115 may, in some examples, monitor for a mismatch between the pre-built second RF script and the RF configuration for the system information indicated via the synchronization signal. For example, the UE 115 may compare the second frequency and the second bandwidth with a frequency and bandwidth indicated via the synchronization signal before acquiring the SIB. In the example of FIG. 7, the UE 115 may pre-build the first and second RF scripts during the DRX on duration of the DRX cycle 705-a and the UE 115 may acquire the synchronization signal (e.g., an SSB, an SSS, or a PSS) during a DRX off duration of the DRX cycle 705-a based on the pre-built first RF script. The synchronization signal may include PBCH information for the UE 115, including an indication of a bandwidth and a frequency of a SIB that includes a CGI for the cell. The UE 115 may compare the frequency and bandwidth indicated via the synchronization signal with the second frequency and second bandwidth used to pre-build the second RF script. If the frequencies and the bandwidths are the same, the UE 115 may use the pre-built second RF script, which may be stored at the UE 115, to configure a channel and acquire the corresponding SIB at the second frequency. The UE 115 may acquire the SIB during the DRX off duration of the same DRX cycle 705-a or during the DRX off duration of the next DRX cycle 705-b, as described with reference to FIG. 6.

In some examples, the UE 115 may determine that the frequency indicated via the synchronization signal is different from the second frequency, the bandwidth indicated via the synchronization signal is different from the second bandwidth, or both. For example, the UE 115 may perform frequency-based fingerprinting, and the second frequency stored at the UE 115 may be associated with a same frequency as the target frequency for the CGI measurement 735, but associated with a second PCI that is different than the target PCI associated with the CGI measurement 735. The PBCH information associated with the second PCI may, in some examples, be different than PBCH information for the target PCI.

If the UE 115 identifies a difference between the second frequency and the frequency indicated via the synchronization signal, between the second bandwidth and the bandwidth indicated via the synchronization signal, or both, the UE 115 will re-build or re-generate the second RF script for the SIB acquisition. The UE 115 may re-build the second RF script based on the frequency and bandwidth indicated via the synchronization signal. The UE 115 may re-build the second RF script during a subsequent DRX on duration, such as the DRX on duration of the DRX cycle 705-b. The UE 115 may configure the channel and acquire the SIB at the frequency indicated via the synchronization signal during the DRX off duration of the DRX cycle 705-b based on the re-built second RF script. A duration of each of the synchronization signal and SIB acquisitions may be less than or the same as a duration of the respective DRX off durations, such that the UE 115 may successfully acquire and decode the corresponding signals.

The UE 115 may transmit a measurement report 720 to the network based on or in response to successfully acquiring the SIB including the CGI for the cell. The measurement report 720 may indicate the CGI. The UE 115 may transmit the measurement report 720 during a DRX on duration of the DRX cycle 705-c that is subsequent to the DRX cycle 705-b in which the UE 115 acquires the SIB. The UE 115 may, in some examples, delete the first RF script and the second RF script to save memory space based on successfully acquiring the synchronization signal and the SIB, respectively, or based on a success of the CGI measurement 735.

The UE 115 may thereby pre-build a first RF script for a synchronization signal acquisition and a second RF script for a SIB acquisition in a same DRX on duration, which may reduce latency and reduce power consumption associated with a CGI measurement 735. The UE 115 may monitor for a mismatch between a previously-determined frequency and a frequency obtained via the synchronization signal. If the UE 115 detects a mismatch, the UE 115 may re-build the second RF script using the received PBCH information in the synchronization signal to improve an accuracy and reliability of the CGI measurement 735.

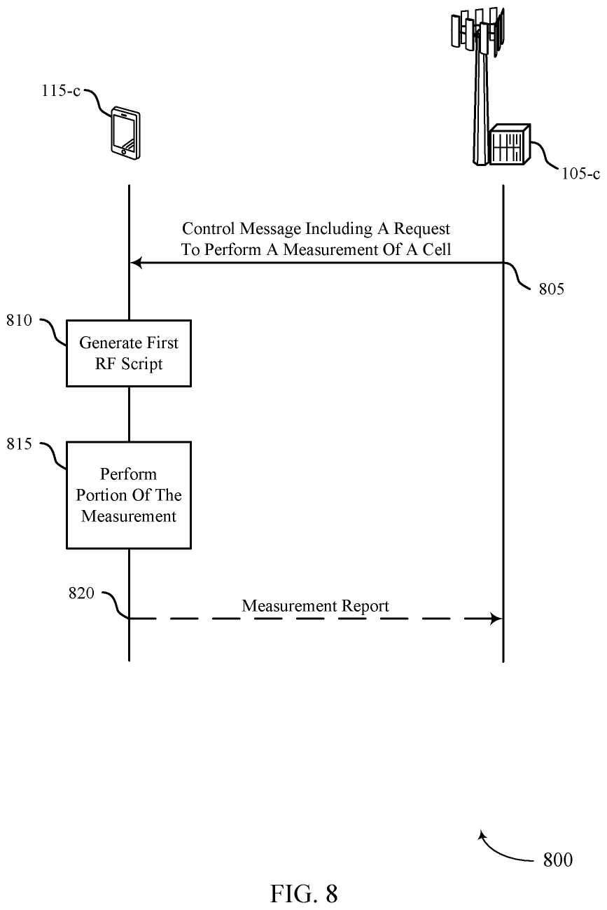

FIG. 8 illustrates an example of a process flow 800 that supports CGI reporting timeline for wireless communications in accordance with aspects of the present disclosure. The process flow 800 may implement or be implemented by aspects of the wireless communications systems 100 and 200 as described with reference to FIGS. 1 and 2, respectively. For example, the process flow 800 may implement or be implemented by a base station 105-c and a UE 115-c, which may be examples of a base station 105 and a UE 115 as described with reference to FIGS. 1 through 7. In some examples, the UE 115-c may be configured to generate one or more RF scripts for a CGI measurement during one or more DRX on durations to improve CGI reporting.

In the following description of the process flow 800, the operations between the base station 105-c and the UE 115-c may be performed in different orders or at different times. Some operations may also be left out of the process flow 800, or other operations may be added. Although the base station 105-c and the UE 115-c are shown performing the operations of the process flow 800, some aspects of some operations may also be performed by one or more other wireless devices.

At 805, the base station 105-c may transmit a control message to the UE 115-c. The control message may include a request to perform a measurement of a cell, (e.g., a CGI measurement). The control message may include an indication of a target frequency associated with the measurement. In some examples, the control message may be transmitted via an RRC reconfiguration message that includes the indication of the target frequency and a second indication of a PCI associated with the measurement.

At 810, the UE 115-c may generate a first RF script based on the target frequency. The target frequency may be associated with a synchronization signal for the UE 115-c. The UE 115-c may generate the first RF script during a first portion of a DRX cycle (e.g., an on duration, an inactivity duration, or both).

At 815, the UE 115-c may perform at least a portion of the measurement based on the first RF script. The UE 115-c may perform the portion of the measurement during a second portion of the DRX cycle (e.g., an off duration). The second portion of the DRX cycle may be different from the first portion of the DRX cycle. The portion of the measurement may be associated with an acquisition of the synchronization signal at the target frequency. The synchronization signal may be an SSB, an SSS, a PSS, or any combination thereof.

At 820, in some examples, the UE 115-c may transmit a measurement report to the base station 105-c. The measurement report may include an indication of a CGI of the cell based on a success of the measurement. For example, the UE 115-c may, in some examples, generate a second RF script associated with a SIB and acquire the SIB based on the second RF script. The SIB may include the CGI for the cell, and the UE 115-c may transmit the measurement report based on acquiring the SIB.

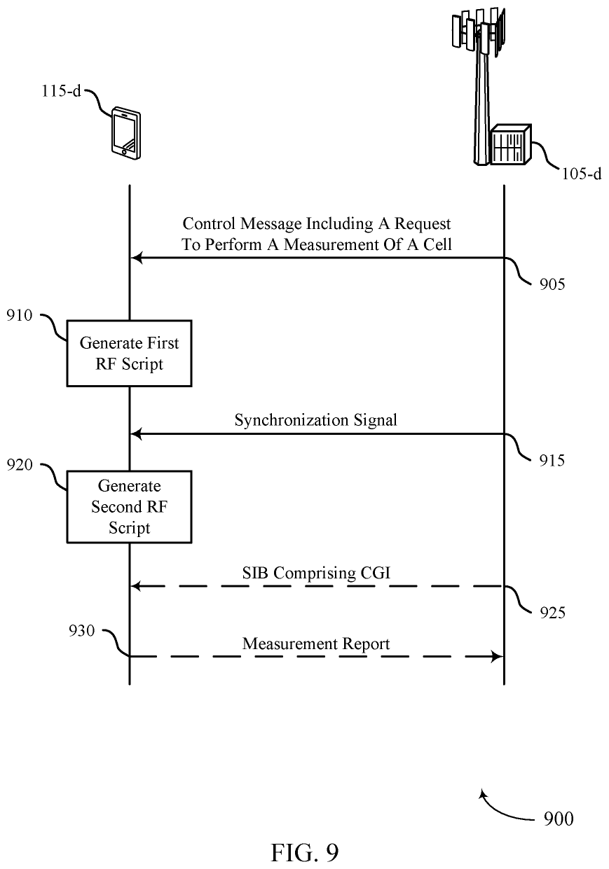

FIG. 9 illustrates an example of a process flow 900 that supports CGI reporting timeline for wireless communications in accordance with aspects of the present disclosure. The process flow 900 may implement or be implemented by aspects of the wireless communications systems 100 and 200 as described with reference to FIGS. 1 and 2, respectively. For example, the process flow 900 may implement or be implemented by a base station 105-d and a UE 115-d, which may be examples of a base station 105 and a UE 115 as described with reference to FIGS. 1 through 8. In some examples, the UE 115-d may be configured to divide a CGI measurement into two or more portions, and perform the portions of the CGI measurement across two or more DRX off durations to improve CGI reporting.

In the following description of the process flow 900, the operations between the base station 105-d and the UE 115-d may be performed in different orders or at different times. Some operations may also be left out of the process flow 900, or other operations may be added. Although the base station 105-d and the UE 115-d are shown performing the operations of the process flow 900, some aspects of some operations may also be performed by one or more other wireless devices.

At 905, the base station 105-d may transmit a control message to the UE 115-d. The control message may include a request to perform a measurement of a cell, (e.g., a CGI measurement). The control message may include an indication of a target frequency associated with the measurement. In some examples, the control message may be transmitted via an RRC reconfiguration message that includes the indication of the target frequency and a second indication of a PCI associated with the measurement.

At 910, the UE 115-d may generate a first RF script. The UE 115-d may generate the first RF script during a first portion of a first DRX cycle of a set of multiple DRX cycles supported by the UE 115-d. The UE 115-d may generate the first RF script based on the target frequency. In some examples, the target frequency may be associated with a synchronization signal.

At 915, the UE 115-d may acquire the synchronization signal. The UE 115-d may acquire the synchronization signal during the first portion of the DRX cycle based on the first RF script. The synchronization signal may indicate a second frequency associated with the measurement. In some examples, the first portion of the DRX cycle may be a DRX off duration, and the UE 115-d may generate the first RF script and acquire the synchronization signal during the DRX off duration.

In some examples, the base station 105-d may transmit the synchronization signal to the UE 115-d. Additionally or alternatively, the UE 115-d may acquire the synchronization signal from some other base station 105 or other device associated with the cell. The synchronization signal may be an SSB, an SSS, a PSS, or any combination thereof.

At 920, the UE 115-d may generate a second RF script during a second portion of a second DRX cycle of the set of multiple DRX cycles. The UE 115-d may generate the second RF script based on the second frequency indicated by the synchronization signal. The second RF script and the second frequency may be associated with a SIB for the UE 115-d. At 925, in some examples, the UE 115-d may acquire the SIB during the second portion of the second DRX cycle at the second frequency based on the second RF script. The SIB may include the CGI for the cell. The second DRX cycle may be subsequent to the first DRX cycle. In some examples, the second portion of the second DRX cycle may be a DRX off duration.

At 930, in some examples, the UE 115-d may transmit a measurement report to the base station 105-d during a third DRX cycle (e.g., a DRX on duration of the third DRX cycle). The measurement report may include an indication of the CGI of the cell based on a success of the CGI measurement. For example, the UE 115-d may transmit the measurement report in response to successfully acquiring the SIB that includes the CGI.

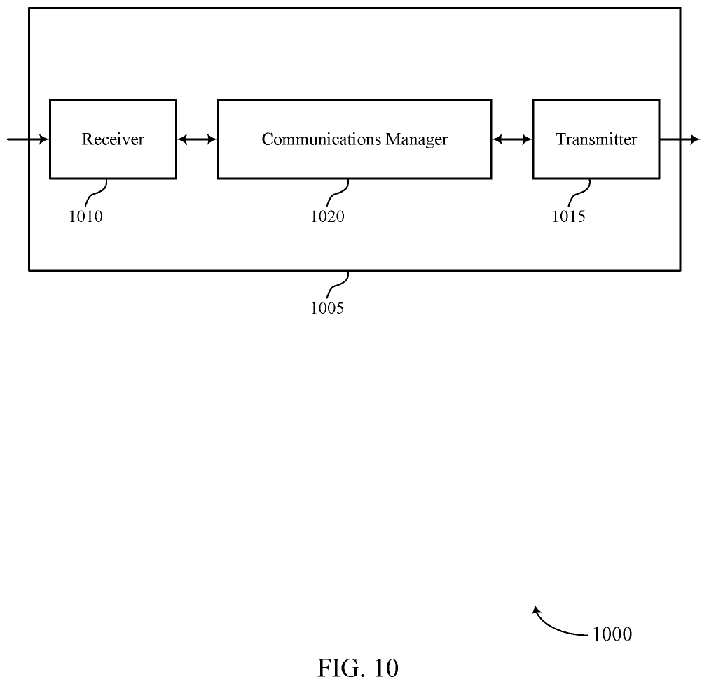

FIG. 10 shows a block diagram 1000 of a device 1005 that supports CGI reporting timeline for wireless communications in accordance with aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to CGI reporting timeline for wireless communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to CGI reporting timeline for wireless communications). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of CGI reporting timeline for wireless communications as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a UE in accordance with examples as disclosed herein. For example, the communications manager 1020 may be configured as or otherwise support a means for receiving a control message including a request to perform a measurement of a cell, the control message including an indication of a target frequency associated with the measurement. The communications manager 1020 may be configured as or otherwise support a means for generating, during a first portion of a DRX cycle, at least a first RF script based on the target frequency, the target frequency associated with a synchronization signal. The communications manager 1020 may be configured as or otherwise support a means for performing, during a second portion of the DRX cycle, at least a portion of the measurement based on the first RF script, the portion of the measurement associated with an acquisition of the synchronization signal at the target frequency, and where the second portion of the DRX cycle is different from the first portion of the DRX cycle.

Additionally or alternatively, the communications manager 1020 may support wireless communication at a UE in accordance with examples as disclosed herein. For example, the communications manager 1020 may be configured as or otherwise support a means for receiving a control message including a request to perform a measurement of a cell, the control message including an indication of a target frequency associated with the measurement. The communications manager 1020 may be configured as or otherwise support a means for generating a first RF script during a first portion of a first DRX cycle of a set of multiple DRX cycles based on the target frequency. The communications manager 1020 may be configured as or otherwise support a means for acquiring a synchronization signal during the first portion based on the first RF script, the synchronization signal indicating a second frequency associated with the measurement. The communications manager 1020 may be configured as or otherwise support a means for generating a second RF script during a second portion of a second DRX cycle of the set of multiple DRX cycles based on the second frequency indicated by the synchronization signal.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing and reduced power consumption. For example, by dividing a CGI measurement into multiple separate tasks, the processor of the device 1005 may complete the CGI measurement faster than if the processor refrains from dividing the CGI measurement. The processor may thereby enter an off state during more DRX cycles (e.g., instead of re-performing the CGI measurement), which may reduce processing and power consumption.

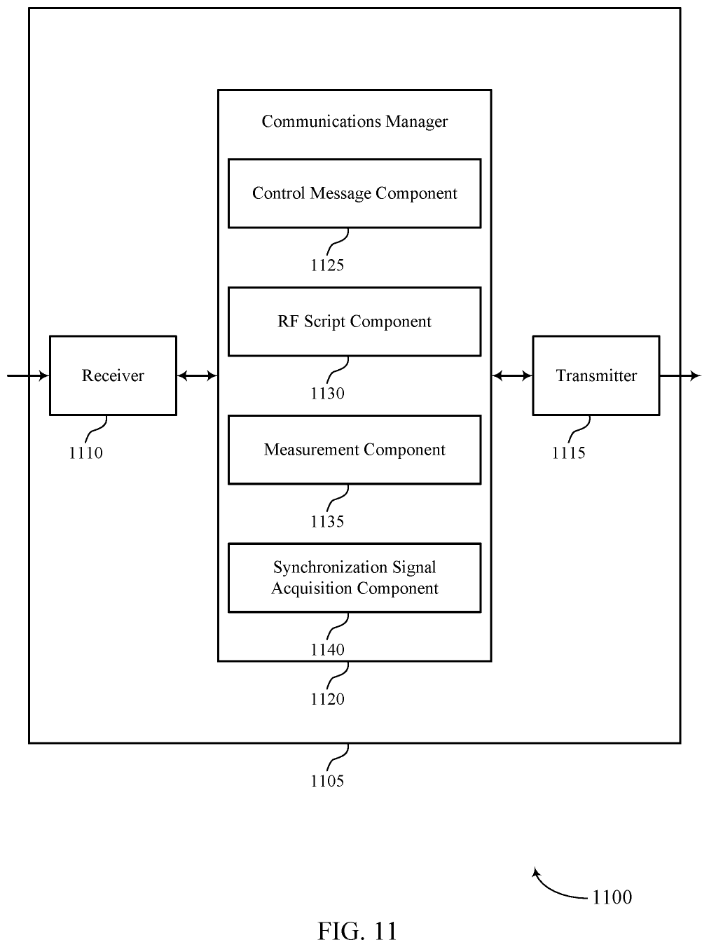

FIG. 11 shows a block diagram 1100 of a device 1105 that supports CGI reporting timeline for wireless communications in accordance with aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to CGI reporting timeline for wireless communications). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to CGI reporting timeline for wireless communications). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of CGI reporting timeline for wireless communications as described herein. For example, the communications manager 1120 may include a control message component 1125, an RF script component 1130, a measurement component 1135, a synchronization signal acquisition component 1140, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a UE in accordance with examples as disclosed herein. The control message component 1125 may be configured as or otherwise support a means for receiving a control message including a request to perform a measurement of a cell, the control message including an indication of a target frequency associated with the measurement. The RF script component 1130 may be configured as or otherwise support a means for generating, during a first portion of a DRX cycle, at least a first RF script based on the target frequency, the target frequency associated with a synchronization signal. The measurement component 1135 may be configured as or otherwise support a means for performing, during a second portion of the DRX cycle, at least a portion of the measurement based on the first RF script, the portion of the measurement associated with an acquisition of the synchronization signal at the target frequency, and where the second portion of the DRX cycle is different from the first portion of the DRX cycle.

Additionally or alternatively, the communications manager 1120 may support wireless communication at a UE in accordance with examples as disclosed herein. The control message component 1125 may be configured as or otherwise support a means for receiving a control message including a request to perform a measurement of a cell, the control message including an indication of a target frequency associated with the measurement. The RF script component 1130 may be configured as or otherwise support a means for generating a first RF script during a first portion of a first DRX cycle of a set of multiple DRX cycles based on the target frequency. The synchronization signal acquisition component 1140 may be configured as or otherwise support a means for acquiring a synchronization signal during the first portion based on the first RF script, the synchronization signal indicating a second frequency associated with the measurement. The RF script component 1130 may be configured as or otherwise support a means for generating a second RF script during a second portion of a second DRX cycle of the set of multiple DRX cycles based on the second frequency indicated by the synchronization signal.

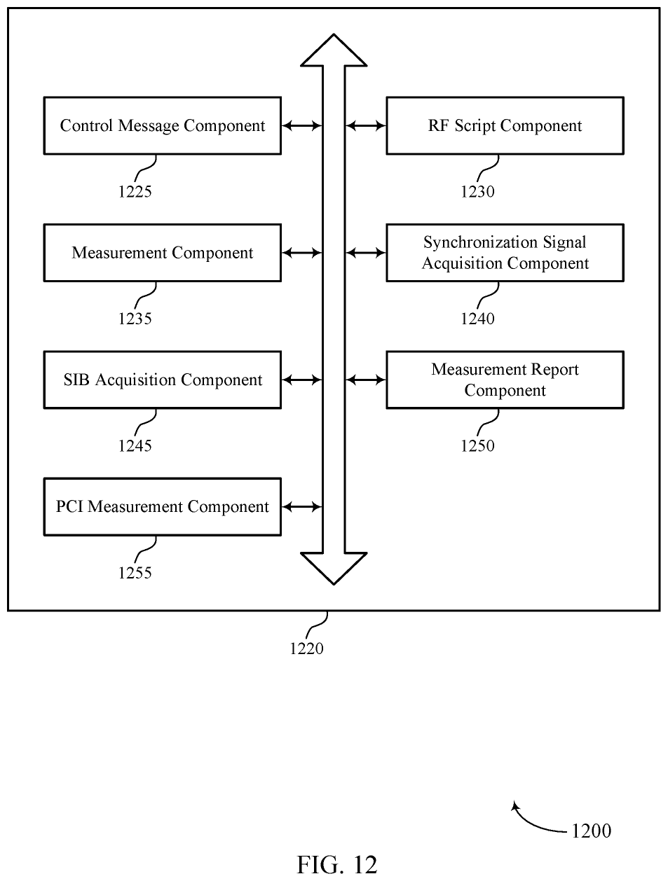

FIG. 12 shows a block diagram 1200 of a communications manager 1220 that supports CGI reporting timeline for wireless communications in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of CGI reporting timeline for wireless communications as described herein. For example, the communications manager 1220 may include a control message component 1225, an RF script component 1230, a measurement component 1235, a synchronization signal acquisition component 1240, an SIB acquisition component 1245, a measurement report component 1250, a PCI measurement component 1255, or any combination thereof. Each of these components may communicate, directly or indirectly, with one another (e.g., via one or more buses).

The communications manager 1220 may support wireless communication at a UE in accordance with examples as disclosed herein. The control message component 1225 may be configured as or otherwise support a means for receiving a control message including a request to perform a measurement of a cell, the control message including an indication of a target frequency associated with the measurement. The RF script component 1230 may be configured as or otherwise support a means for generating, during a first portion of a DRX cycle, at least a first RF script based on the target frequency, the target frequency associated with a synchronization signal. The measurement component 1235 may be configured as or otherwise support a means for performing, during a second portion of the DRX cycle, at least a portion of the measurement based on the first RF script, the portion of the measurement associated with an acquisition of the synchronization signal at the target frequency, and where the second portion of the DRX cycle is different from the first portion of the DRX cycle.

In some examples, the RF script component 1230 may be configured as or otherwise support a means for generating, during a third portion of a second DRX cycle, a second RF script based on an RF configuration of system information for the UE, where the synchronization signal acquired during the second portion of the DRX cycle includes the system information. In some examples, the measurement component 1235 may be configured as or otherwise support a means for performing, during a fourth portion of the second DRX cycle, a second portion of the measurement based on the second RF script. In some examples, to perform the second portion of the measurement, the SIB acquisition component 1245 may be configured as or otherwise support a means for acquiring a SIB based on the second RF script, the SIB including a CGI of the cell associated with the measurement.

In some examples, the RF script component 1230 may be configured as or otherwise support a means for generating the first RF script and a second RF script during the first portion of the DRX cycle, the second RF script associated with a second portion of the measurement.

In some examples, the SIB acquisition component 1245 may be configured as or otherwise support a means for performing the second portion of the measurement during a fourth portion of a second DRX cycle subsequent to the DRX cycle based on the second RF script, the second DRX cycle including a third portion prior to the fourth portion, where the second portion of the measurement is associated with an acquisition of a SIB that includes a CGI of the cell associated with the measurement.

In some examples, the SIB acquisition component 1245 may be configured as or otherwise support a means for performing the second portion of the measurement during the second portion of the DRX cycle based on the second RF script, where the second portion of the measurement is associated with an acquisition of a SIB that includes a CGI of the cell associated with the measurement.

In some examples, the PCI measurement component 1255 may be configured as or otherwise support a means for performing a PCI measurement associated with the target frequency prior to the first portion of the DRX cycle. In some examples, the PCI measurement component 1255 may be configured as or otherwise support a means for determining a second frequency associated with a SIB for the UE based on the PCI measurement. In some examples, the RF script component 1230 may be configured as or otherwise support a means for generating the second RF script based on the second frequency.

In some examples, to support performing the first portion of the measurement, the synchronization signal acquisition component 1240 may be configured as or otherwise support a means for acquiring the synchronization signal during the second portion of the DRX cycle, the synchronization signal including system information that indicates a third frequency associated with the SIB for the UE. In some examples, to support performing the first portion of the measurement, the RF script component 1230 may be configured as or otherwise support a means for determining that the third frequency is different than the second frequency. In some examples, to support performing the first portion of the measurement, the RF script component 1230 may be configured as or otherwise support a means for re-generating, during a third portion of a second DRX cycle, the second RF script based on the third frequency being different than the second frequency, where re-generating the second RF script is based on the third frequency.

In some examples, the measurement component 1235 may be configured as or otherwise support a means for identifying a failure of the first portion of the measurement during the second portion of the DRX cycle. In some examples, the measurement component 1235 may be configured as or otherwise support a means for re-performing the first portion of the measurement during a fourth portion of a second DRX cycle subsequent to the DRX cycle based on identifying the failure, the second DRX cycle including a third portion prior to the fourth portion, where re-performing the first portion of the measurement is based on the first RF script.

In some examples, the RF script component 1230 may be configured as or otherwise support a means for storing the first RF script in a database of the UE after generating the first RF script. In some examples, the RF script component 1230 may be configured as or otherwise support a means for deleting the first RF script from the database based on a success of the first portion of the measurement.

In some examples, the measurement report component 1250 may be configured as or otherwise support a means for transmitting a measurement report including an indication of a CGI of the cell based on a success of the measurement.

In some examples, to support receiving the control message, the control message component 1225 may be configured as or otherwise support a means for receiving a RRC reconfiguration message that includes the indication of the target frequency and a second indication of a PCI associated with the measurement. In some examples, the first portion of the DRX cycle includes an on duration of the DRX cycle. In some examples, the second portion of the DRX cycle includes an off duration of the DRX cycle.

Additionally or alternatively, the communications manager 1220 may support wireless communication at a UE in accordance with examples as disclosed herein. In some examples, the control message component 1225 may be configured as or otherwise support a means for receiving a control message including a request to perform a measurement of a cell, the control message including an indication of a target frequency associated with the measurement. In some examples, the RF script component 1230 may be configured as or otherwise support a means for generating a first RF script during a first portion of a first DRX cycle of a set of multiple DRX cycles based on the target frequency. The synchronization signal acquisition component 1240 may be configured as or otherwise support a means for acquiring a synchronization signal during the first portion based on the first RF script, the synchronization signal indicating a second frequency associated with the measurement. In some examples, the RF script component 1230 may be configured as or otherwise support a means for generating a second RF script during a second portion of a second DRX cycle of the set of multiple DRX cycles based on the second frequency indicated by the synchronization signal.

In some examples, the SIB acquisition component 1245 may be configured as or otherwise support a means for acquiring, during the second portion of the second DRX cycle, a SIB based on the second RF script, where the SIB includes a CGI of the cell associated with the measurement. In some examples, the measurement report component 1250 may be configured as or otherwise support a means for transmitting, during a third DRX cycle, a measurement report including an indication of the CGI of the cell based on acquiring the SIB.

In some examples, to support receiving the control message, the control message component 1225 may be configured as or otherwise support a means for receiving a RRC reconfiguration message that includes the indication of the target frequency and a second indication of a PCI associated with the measurement. In some examples, the first portion includes an off duration of the first DRX cycle. In some examples, the second portion includes an off duration of the second DRX cycle.

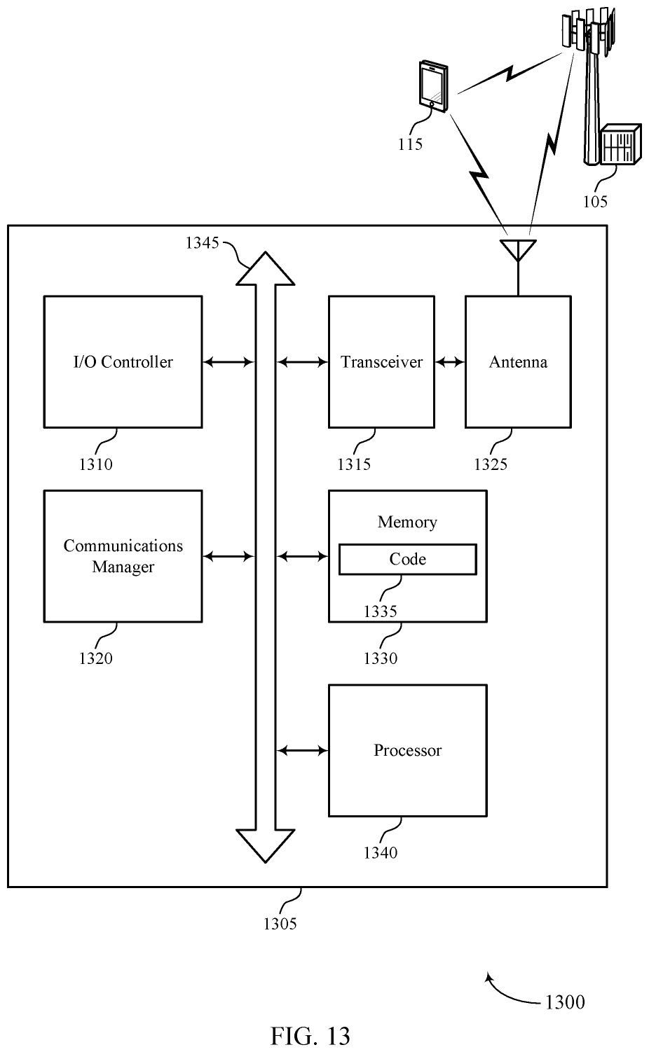

FIG. 13 shows a diagram of a system 1300 including a device 1305 that supports CGI reporting timeline for wireless communications in accordance with aspects of the present disclosure. The device 1305 may be an example of or include the components of a device 1005, a device 1105, or a UE 115 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting CGI reporting timeline for wireless communications). For example, the device 1305 or a component of the device 1305 may include a processor 1340 and memory 1330 coupled to the processor 1340, the processor 1340 and memory 1330 configured to perform various functions described herein.

The communications manager 1320 may support wireless communication at a UE in accordance with examples as disclosed herein. For example, the communications manager 1320 may be configured as or otherwise support a means for receiving a control message including a request to perform a measurement of a cell, the control message including an indication of a target frequency associated with the measurement. The communications manager 1320 may be configured as or otherwise support a means for generating, during a first portion of a DRX cycle, at least a first RF script based on the target frequency, the target frequency associated with a synchronization signal. The communications manager 1320 may be configured as or otherwise support a means for performing, during a second portion of the DRX cycle, at least a portion of the measurement based on the first RF script, the portion of the measurement associated with an acquisition of the synchronization signal at the target frequency, and where the second portion of the DRX cycle is different from the first portion of the DRX cycle.

Additionally or alternatively, the communications manager 1320 may support wireless communication at a UE in accordance with examples as disclosed herein. For example, the communications manager 1320 may be configured as or otherwise support a means for receiving a control message including a request to perform a measurement of a cell, the control message including an indication of a target frequency associated with the measurement. The communications manager 1320 may be configured as or otherwise support a means for generating a first RF script during a first portion of a first DRX cycle of a set of multiple DRX cycles based on the target frequency. The communications manager 1320 may be configured as or otherwise support a means for acquiring a synchronization signal during the first portion based on the first RF script, the synchronization signal indicating a second frequency associated with the measurement. The communications manager 1320 may be configured as or otherwise support a means for generating a second RF script during a second portion of a second DRX cycle of the set of multiple DRX cycles based on the second frequency indicated by the synchronization signal.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of CGI reporting timeline for wireless communications as described herein, or the processor 1340 and the memory 1330 may be otherwise configured to perform or support such operations.

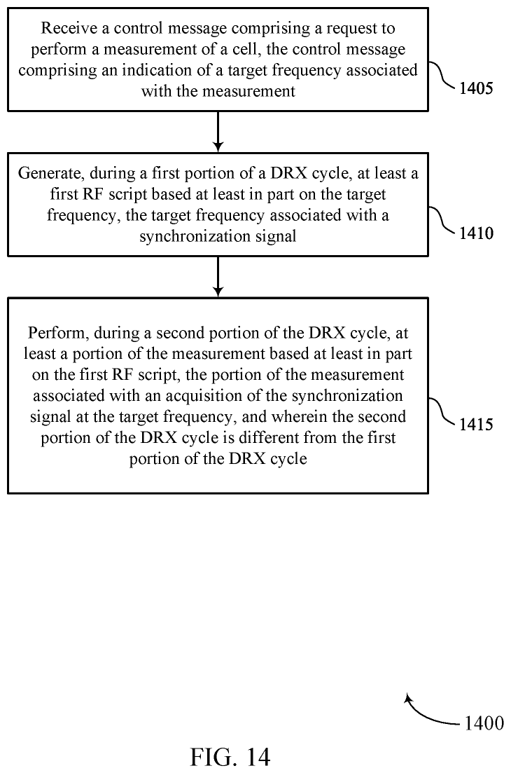

FIG. 14 shows a flowchart illustrating a method 1400 that supports CGI reporting timeline for wireless communications in accordance with aspects of the present disclosure. The operations of the method 1400 may be implemented by a UE or its components as described herein. For example, the operations of the method 1400 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1405, the method may include receiving a control message including a request to perform a measurement of a cell, the control message including an indication of a target frequency associated with the measurement. The operations of 1405 may be performed in accordance with examples as disclosed herein. In some examples, aspects of the operations of 1405 may be performed by a control message component 1225 as described with reference to FIG. 12.

At 1410, the method may include generating, during a first portion of a DRX cycle, at least a first RF script based on the target frequency, the target frequency associated with a synchronization signal. The operations of 1410 may be performed in accordance with examples as disclosed herein. In some examples, aspects of the operations of 1410 may be performed by an RF script component 1230 as described with reference to FIG. 12.

At 1415, the method may include performing, during a second portion of the DRX cycle, at least a portion of the measurement based on the first RF script, the portion of the measurement associated with an acquisition of the synchronization signal at the target frequency, and where the second portion of the DRX cycle is different from the first portion of the DRX cycle. The operations of 1415 may be performed in accordance with examples as disclosed herein. In some examples, aspects of the operations of 1415 may be performed by a measurement component 1235 as described with reference to FIG. 12.

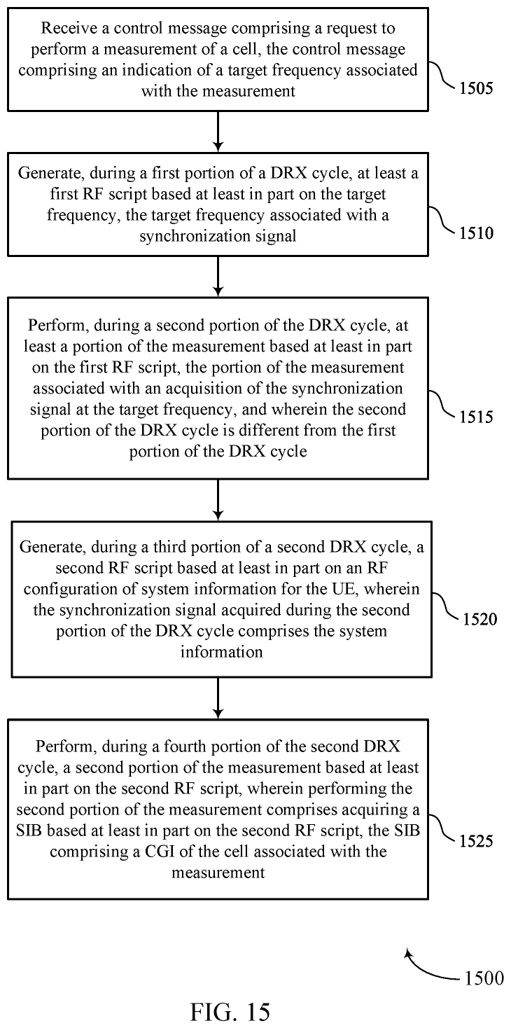

FIG. 15 shows a flowchart illustrating a method 1500 that supports CGI reporting timeline for wireless communications in accordance with aspects of the present disclosure. The operations of the method 1500 may be implemented by a UE or its components as described herein. For example, the operations of the method 1500 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1505, the method may include receiving a control message including a request to perform a measurement of a cell, the control message including an indication of a target frequency associated with the measurement. The operations of 1505 may be performed in accordance with examples as disclosed herein. In some examples, aspects of the operations of 1505 may be performed by a control message component 1225 as described with reference to FIG. 12.

At 1510, the method may include generating, during a first portion of a DRX cycle, at least a first RF script based on the target frequency, the target frequency associated with a synchronization signal. The operations of 1510 may be performed in accordance with examples as disclosed herein. In some examples, aspects of the operations of 1510 may be performed by an RF script component 1230 as described with reference to FIG. 12.

At 1515, the method may include performing, during a second portion of the DRX cycle, at least a portion of the measurement based on the first RF script, the portion of the measurement associated with an acquisition of the synchronization signal at the target frequency, and where the second portion of the DRX cycle is different from the first portion of the DRX cycle. The operations of 1515 may be performed in accordance with examples as disclosed herein. In some examples, aspects of the operations of 1515 may be performed by a measurement component 1235 as described with reference to FIG. 12.

At 1520, the method may include generating, during a third portion of a second DRX cycle, a second RF script based on an RF configuration of system information for the UE, where the synchronization signal acquired during the second portion of the DRX cycle includes the system information. The operations of 1520 may be performed in accordance with examples as disclosed herein. In some examples, aspects of the operations of 1520 may be performed by an RF script component 1230 as described with reference to FIG. 12.

At 1525, the method may include performing, during a fourth portion of the second DRX cycle, a second portion of the measurement based on the second RF script. In some examples, performing the second portion of the measurement may include acquiring a SIB based on the second RF script, the SIB including a CGI of the cell associated with the measurement. The operations of 1525 may be performed in accordance with examples as disclosed herein. In some examples, aspects of the operations of 1525 may be performed by a measurement component 1235, a SIB acquisition component 1245, or both as described with reference to FIG. 12.

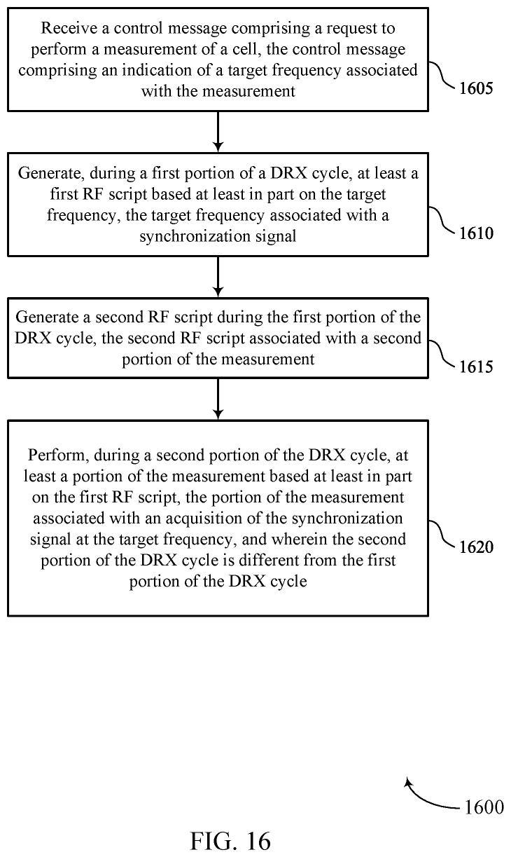

FIG. 16 shows a flowchart illustrating a method 1600 that supports CGI reporting timeline for wireless communications in accordance with aspects of the present disclosure. The operations of the method 1600 may be implemented by a UE or its components as described herein. For example, the operations of the method 1600 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1605, the method may include receiving a control message including a request to perform a measurement of a cell, the control message including an indication of a target frequency associated with the measurement. The operations of 1605 may be performed in accordance with examples as disclosed herein. In some examples, aspects of the operations of 1605 may be performed by a control message component 1225 as described with reference to FIG. 12.

At 1610, the method may include generating, during a first portion of a DRX cycle, at least a first RF script based on the target frequency, the target frequency associated with a synchronization signal. The operations of 1610 may be performed in accordance with examples as disclosed herein. In some examples, aspects of the operations of 1610 may be performed by an RF script component 1230 as described with reference to FIG. 12.

At 1615, the method may include generating a second RF script during the first portion of the DRX cycle, the second RF script associated with a second portion of the measurement. The operations of 1615 may be performed in accordance with examples as disclosed herein. In some examples, aspects of the operations of 1615 may be performed by an RF script component 1230 as described with reference to FIG. 12.

At 1620, the method may include performing, during a second portion of the DRX cycle, at least a portion of the measurement based on the first RF script, the portion of the measurement associated with an acquisition of the synchronization signal at the target frequency, and where the second portion of the DRX cycle is different from the first portion of the DRX cycle. The operations of 1620 may be performed in accordance with examples as disclosed herein. In some examples, aspects of the operations of 1620 may be performed by a measurement component 1235 as described with reference to FIG. 12.

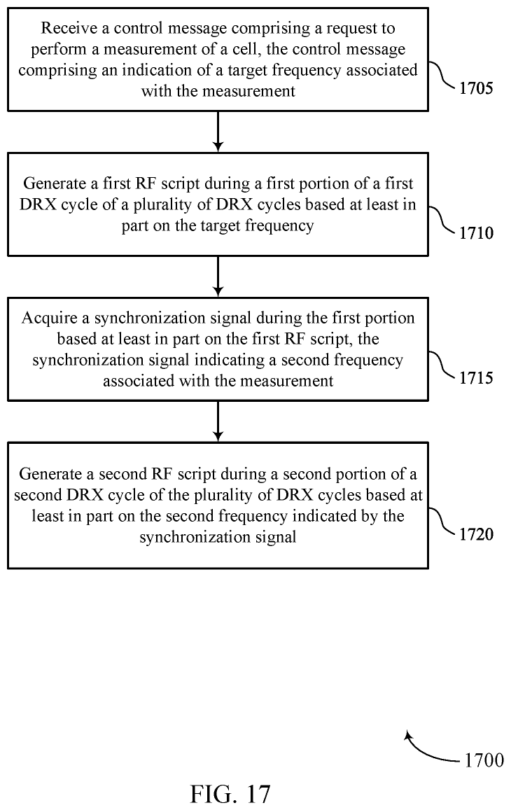

FIG. 17 shows a flowchart illustrating a method 1700 that supports CGI reporting timeline for wireless communications in accordance with aspects of the present disclosure. The operations of the method 1700 may be implemented by a UE or its components as described herein. For example, the operations of the method 1700 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1705, the method may include receiving a control message including a request to perform a measurement of a cell, the control message including an indication of a target frequency associated with the measurement. The operations of 1705 may be performed in accordance with examples as disclosed herein. In some examples, aspects of the operations of 1705 may be performed by a control message component 1225 as described with reference to FIG. 12.

At 1710, the method may include generating a first RF script during a first portion of a first DRX cycle of a set of multiple DRX cycles based on the target frequency. The operations of 1710 may be performed in accordance with examples as disclosed herein. In some examples, aspects of the operations of 1710 may be performed by an RF script component 1230 as described with reference to FIG. 12.

At 1715, the method may include acquiring a synchronization signal during the first portion based on the first RF script, the synchronization signal indicating a second frequency associated with the measurement. The operations of 1715 may be performed in accordance with examples as disclosed herein. In some examples, aspects of the operations of 1715 may be performed by a synchronization signal acquisition component 1240 as described with reference to FIG. 12.

At 1720, the method may include generating a second RF script during a second portion of a second DRX cycle of the set of multiple DRX cycles based on the second frequency indicated by the synchronization signal. The operations of 1720 may be performed in accordance with examples as disclosed herein. In some examples, aspects of the operations of 1720 may be performed by an RF script component 1230 as described with reference to FIG. 12.

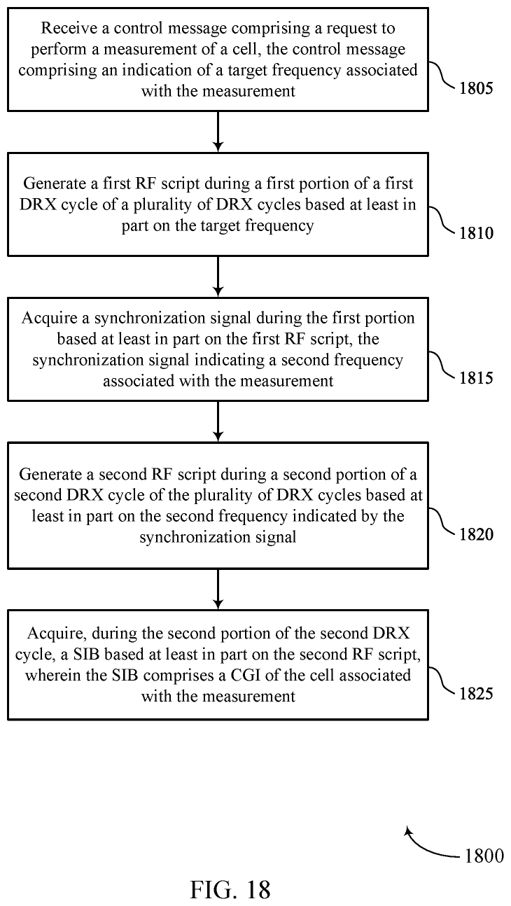

FIG. 18 shows a flowchart illustrating a method 1800 that supports CGI reporting timeline for wireless communications in accordance with aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1805, the method may include receiving a control message including a request to perform a measurement of a cell, the control message including an indication of a target frequency associated with the measurement. The operations of 1805 may be performed in accordance with examples as disclosed herein. In some examples, aspects of the operations of 1805 may be performed by a control message component 1225 as described with reference to FIG. 12.

At 1810, the method may include generating a first RF script during a first portion of a first DRX cycle of a set of multiple DRX cycles based on the target frequency. The operations of 1810 may be performed in accordance with examples as disclosed herein. In some examples, aspects of the operations of 1810 may be performed by an RF script component 1230 as described with reference to FIG. 12.

At 1815, the method may include acquiring a synchronization signal during the first portion based on the first RF script, the synchronization signal indicating a second frequency associated with the measurement. The operations of 1815 may be performed in accordance with examples as disclosed herein. In some examples, aspects of the operations of 1815 may be performed by a synchronization signal acquisition component 1240 as described with reference to FIG. 12.

At 1820, the method may include generating a second RF script during a second portion of a second DRX cycle of the set of multiple DRX cycles based on the second frequency indicated by the synchronization signal. The operations of 1820 may be performed in accordance with examples as disclosed herein. In some examples, aspects of the operations of 1820 may be performed by an RF script component 1230 as described with reference to FIG. 12.

At 1825, the method may include acquiring, during the second portion of the second DRX cycle, a SIB based on the second RF script, where the SIB includes a CGI of the cell associated with the measurement. The operations of 1825 may be performed in accordance with examples as disclosed herein. In some examples, aspects of the operations of 1825 may be performed by an SIB acquisition component 1245 as described with reference to FIG. 12.

The following aspects are given by way of illustration. Examples of the following aspects may be combined with examples or embodiments shown or discussed in relation to the figures or elsewhere herein:

Aspect 1: A method for wireless communication at a UE, comprising: receiving a control message comprising a request to perform a measurement of a cell, the control message comprising an indication of a target frequency associated with the measurement; generating, during a first portion of a DRX cycle, at least a first RF script based at least in part on the target frequency, the target frequency associated with a synchronization signal; and performing, during a second portion of the DRX cycle, at least a portion of the measurement based at least in part on the first RF script, the portion of the measurement associated with an acquisition of the synchronization signal at the target frequency, and wherein the second portion of the DRX cycle is different from the first portion of the DRX cycle.

Aspect 2: The method of aspect 1, further comprising: generating, during a third portion of a second DRX cycle, a second RF script based at least in part on a RF configuration of system information for the UE, wherein the synchronization signal acquired during the second portion of the DRX cycle comprises the system information; and performing, during a fourth portion of the second DRX cycle, a second portion of the measurement based at least in part on the second RF script, wherein performing the second portion of the measurement comprises: acquiring a SIB based at least in part on the second RF script, the SIB comprising a CGI of the cell associated with the measurement.

Aspect 3: The method of any of aspect 1, further comprising: generating the first RF script and a second RF script during the first portion of the DRX cycle, the second RF script associated with a second portion of the measurement.

Aspect 4: The method of aspect 3, further comprising: performing the second portion of the measurement during a fourth portion of a second DRX cycle subsequent to the DRX cycle based at least in part on the second RF script, the second DRX cycle comprising a third portion prior to the fourth portion, wherein the second portion of the measurement is associated with an acquisition of a SIB that comprises a CGI of the cell associated with the measurement.

Aspect 5: The method of any of aspect 3, further comprising: performing the second portion of the measurement during the second portion of the DRX cycle based at least in part on the second RF script, wherein the second portion of the measurement is associated with an acquisition of a SIB that comprises a CGI of the cell associated with the measurement.

Aspect 6: The method of any of aspects 3 through 5, further comprising: performing a PCI measurement associated with the target frequency prior to the first portion of the DRX cycle; determining a second frequency associated with a SIB for the UE based at least in part on the PCI measurement; and generating the second RF script based at least in part on the second frequency.

Aspect 7: The method of aspect 6, wherein performing the first portion of the measurement comprises: acquiring the synchronization signal during the second portion of the DRX cycle, the synchronization signal comprising system information that indicates a third frequency associated with the SIB for the UE; determining that the third frequency is different than the second frequency; and re-generating, during a third portion of a second DRX cycle, the second RF script based at least in part on the third frequency being different than the second frequency, wherein re-generating the second RF script is based at least in part on the third frequency.

Aspect 8: The method of any of aspects 1 through 7, further comprising: identifying a failure of the first portion of the measurement during the second portion of the DRX cycle; and re-performing the first portion of the measurement during a fourth portion of a second DRX cycle subsequent to the DRX cycle based at least in part on identifying the failure, the second DRX cycle comprising a third portion prior to the fourth portion, wherein re-performing the first portion of the measurement is based at least in part on the first RF script.

Aspect 9: The method of any of aspects 1 through 8, further comprising: storing the first RF script in a database of the UE after generating the first RF script; and deleting the first RF script from the database based at least in part on a success of the first portion of the measurement.

Aspect 10: The method of any of aspects 1 through 9, further comprising: transmitting a measurement report comprising an indication of a CGI of the cell based at least in part on a success of the measurement.

Aspect 11: The method of any of aspects 1 through 10, wherein receiving the control message comprises: receiving an RRC reconfiguration message that comprises the indication of the target frequency and a second indication of a PCI associated with the measurement.

Aspect 12: The method of any of aspects 1 through 11, wherein the first portion of the DRX cycle comprises an on duration of the DRX cycle; and the second portion of the DRX cycle comprises an off duration of the DRX cycle.

Aspect 13: A method for wireless communication at a UE, comprising: receiving a control message comprising a request to perform a measurement of a cell, the control message comprising an indication of a target frequency associated with the measurement; generating a first RF script during a first portion of a first DRX cycle of a plurality of DRX cycles based at least in part on the target frequency; acquiring a synchronization signal during the first portion based at least in part on the first RF script, the synchronization signal indicating a second frequency associated with the measurement; and generating a second RF script during a second portion of a second DRX cycle of the plurality of DRX cycles based at least in part on the second frequency indicated by the synchronization signal.

Aspect 14: The method of aspect 13, further comprising: acquiring, during the second portion of the second DRX cycle, a SIB based at least in part on the second RF script, wherein the SIB comprises a CGI of the cell associated with the measurement.

Aspect 15: The method of aspect 14, further comprising: transmitting, during a third DRX cycle, a measurement report comprising an indication of the CGI of the cell based at least in part on acquiring the SIB.

Aspect 16: The method of any of aspects 13 through 15, wherein receiving the control message comprises: receiving an RRC reconfiguration message that comprises the indication of the target frequency and a second indication of a PCI associated with the measurement.

Aspect 17: The method of any of aspects 13 through 16, wherein the first portion comprises an off duration of the first DRX cycle; and the second portion comprises an off duration of the second DRX cycle.

Aspect 18: An apparatus for wireless communication at a UE, comprising a processor; memory coupled with the processor; and instructions stored in the memory and executable by the processor to cause the apparatus to perform a method of any of aspects 1 through 12.

Aspect 19: An apparatus for wireless communication at a UE, comprising at least one means for performing a method of any of aspects 1 through 12.

Aspect 20: A non-transitory computer-readable medium storing code for wireless communication at a UE, the code comprising instructions executable by a processor to perform a method of any of aspects 1 through 12.

Aspect 21: An apparatus for wireless communication at a UE, comprising a processor; memory coupled with the processor; and instructions stored in the memory and executable by the processor to cause the apparatus to perform a method of any of aspects 13 through 17.

Aspect 22: An apparatus for wireless communication at a UE, comprising at least one means for performing a method of any of aspects 13 through 17.

Aspect 23: A non-transitory computer-readable medium storing code for wireless communication at a UE, the code comprising instructions executable by a processor to perform a method of any of aspects 13 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a control message comprising a request to perform a measurement of a cell, the control message comprising an indication of a target frequency associated with the measurement;
generating, during a first portion of a discontinuous reception cycle, at least a first radio frequency script based at least in part on the target frequency, the target frequency associated with a synchronization signal; and
performing, during a second portion of the discontinuous reception cycle, at least a portion of the measurement based at least in part on the first radio frequency script, the portion of the measurement associated with an acquisition of the synchronization signal at the target frequency, and wherein the second portion of the discontinuous reception cycle is different from the first portion of the discontinuous reception cycle.

2. The method of claim 1, further comprising:
generating, during a third portion of a second discontinuous reception cycle, a second radio frequency script based at least in part on a radio frequency configuration of system information for the UE, wherein the synchronization signal acquired during the second portion of the discontinuous reception cycle comprises the system information; and
performing, during a fourth portion of the second discontinuous reception cycle, a second portion of the measurement based at least in part on the second radio frequency script, wherein performing the second portion of the measurement comprises:
acquiring a system information block based at least in part on the second radio frequency script, the system information block comprising a cell global identity of the cell associated with the measurement.

3. The method of claim 1, further comprising:
generating the first radio frequency script and a second radio frequency script during the first portion of the discontinuous reception cycle, the second radio frequency script associated with a second portion of the measurement.

4. The method of claim 3, further comprising:
performing the second portion of the measurement during a fourth portion of a second discontinuous reception cycle subsequent to the discontinuous reception cycle based at least in part on the second radio frequency script, the second discontinuous reception cycle comprising a third portion prior to the fourth portion, wherein the second portion of the measurement is associated with an acquisition of a system information block that comprises a cell global identity of the cell associated with the measurement.

5. The method of claim 3, further comprising:
performing the second portion of the measurement during the second portion of the discontinuous reception cycle based at least in part on the second radio frequency script, wherein the second portion of the measurement is associated with an acquisition of a system information block that comprises a cell global identity of the cell associated with the measurement.

6. The method of claim 3, further comprising:
performing a physical cell identity measurement associated with the target frequency prior to the first portion of the discontinuous reception cycle;
determining a second frequency associated with a system information block for the UE based at least in part on the physical cell identity measurement; and
generating the second radio frequency script based at least in part on the second frequency.

7. The method of claim 6, wherein performing the first portion of the measurement comprises:
acquiring the synchronization signal during the second portion of the discontinuous reception cycle, the synchronization signal comprising system information that indicates a third frequency associated with the system information block for the UE;
determining that the third frequency is different than the second frequency; and
re-generating, during a third portion of a second discontinuous reception cycle, the second radio frequency script based at least in part on the third frequency being different than the second frequency, wherein re-generating the second radio frequency script is based at least in part on the third frequency.

8. The method of claim 1, further comprising:
identifying a failure of the first portion of the measurement during the second portion of the discontinuous reception cycle; and
re-performing the first portion of the measurement during a fourth portion of a second discontinuous reception cycle subsequent to the discontinuous reception cycle based at least in part on identifying the failure, the second discontinuous reception cycle comprising a third portion prior to the fourth portion, wherein re-performing the first portion of the measurement is based at least in part on the first radio frequency script.

9. The method of claim 1, further comprising:
storing the first radio frequency script in a database of the UE after generating the first radio frequency script; and
deleting the first radio frequency script from the database based at least in part on a success of the first portion of the measurement.

10. The method of claim 1, further comprising:
transmitting a measurement report comprising an indication of a cell global identity of the cell based at least in part on a success of the measurement.

11. The method of claim 1, wherein receiving the control message comprises:
receiving a radio resource control reconfiguration message that comprises the indication of the target frequency and a second indication of a physical cell identity associated with the measurement.

12. The method of claim 1, wherein:
the first portion of the discontinuous reception cycle comprises an on duration of the discontinuous reception cycle; and
the second portion of the discontinuous reception cycle comprises an off duration of the discontinuous reception cycle.

13. A method for wireless communication at a user equipment (UE), comprising:
receiving a control message comprising a request to perform a measurement of a cell, the control message comprising an indication of a target frequency associated with the measurement;
generating a first radio frequency script during a first portion of a first discontinuous reception cycle of a plurality of discontinuous reception cycles based at least in part on the target frequency;
acquiring a synchronization signal during the first portion based at least in part on the first radio frequency script, the synchronization signal indicating a second frequency associated with the measurement; and
generating a second radio frequency script during a second portion of a second discontinuous reception cycle of the plurality of discontinuous reception cycles based at least in part on the second frequency indicated by the synchronization signal.

14. The method of claim 13, further comprising:
acquiring, during the second portion of the second discontinuous reception cycle, a system information block based at least in part on the second radio frequency script, wherein the system information block comprises a cell global identity of the cell associated with the measurement.

15. The method of claim 14, further comprising:
transmitting, during a third discontinuous reception cycle, a measurement report comprising an indication of the cell global identity of the cell based at least in part on acquiring the system information block.

16. The method of claim 13, wherein receiving the control message comprises:
receiving a radio resource control reconfiguration message that comprises the indication of the target frequency and a second indication of a physical cell identity associated with the measurement.

17. The method of claim 13, wherein:
the first portion comprises an off duration of the first discontinuous reception cycle; and
the second portion comprises an off duration of the second discontinuous reception cycle.

18. An apparatus for wireless communication at a user equipment (UE), comprising:
a processor;
memory coupled with the processor; and
instructions stored in the memory and executable by the processor to cause the apparatus to:
receive a control message comprising a request to perform a measurement of a cell, the control message comprising an indication of a target frequency associated with the measurement;
generate, during a first portion of a discontinuous reception cycle, at least a first radio frequency script based at least in part on the target frequency, the target frequency associated with a synchronization signal; and
perform, during a second portion of the discontinuous reception cycle, at least a portion of the measurement based at least in part on the first radio frequency script, the portion of the measurement associated with an acquisition of the synchronization signal at the target frequency, and wherein the second portion of the discontinuous reception cycle is different from the first portion of the discontinuous reception cycle.

19. The apparatus of claim 18, wherein the instructions are further executable by the processor to cause the apparatus to:
generate, during a third portion of a second discontinuous reception cycle, a second radio frequency script based at least in part on a radio frequency configuration of system information for the UE, wherein the synchronization signal acquired during the second portion of the discontinuous reception cycle comprises the system information; and
perform, during a fourth portion of the second discontinuous reception cycle, a second portion of the measurement based at least in part on the second radio frequency script, wherein performing the second portion of the measurement comprises:
acquire a system information block based at least in part on the second radio frequency script, the system information block comprising a cell global identity of the cell associated with the measurement.

20. The apparatus of claim 18, wherein the instructions are further executable by the processor to cause the apparatus to:
generate the first radio frequency script and a second radio frequency script during the first portion of the discontinuous reception cycle, the second radio frequency script associated with a second portion of the measurement.

21. The apparatus of claim 20, wherein the instructions are further executable by the processor to cause the apparatus to:
perform the second portion of the measurement during a fourth portion of a second discontinuous reception cycle subsequent to the discontinuous reception cycle based at least in part on the second radio frequency script, the second discontinuous reception cycle comprising a third portion prior to the fourth portion, wherein the second portion of the measurement is associated with an acquisition of a system information block that comprises a cell global identity of the cell associated with the measurement.

22. The apparatus of claim 20, wherein the instructions are further executable by the processor to cause the apparatus to:
perform the second portion of the measurement during the second portion of the discontinuous reception cycle based at least in part on the second radio frequency script, wherein the second portion of the measurement is associated with an acquisition of a system information block that comprises a cell global identity of the cell associated with the measurement.

23. The apparatus of claim 20, wherein the instructions are further executable by the processor to cause the apparatus to:
perform a physical cell identity measurement associated with the target frequency prior to the first portion of the discontinuous reception cycle;
determine a second frequency associated with a system information block for the UE based at least in part on the physical cell identity measurement; and
generate the second radio frequency script based at least in part on the second frequency.

24. The apparatus of claim 23, wherein the instructions to perform the first portion of the measurement are executable by the processor to cause the apparatus to:
acquire the synchronization signal during the second portion of the discontinuous reception cycle, the synchronization signal comprising system information that indicates a third frequency associated with the system information block for the UE;
determine that the third frequency is different than the second frequency; and
re-generate, during a third portion of a second discontinuous reception cycle, the second radio frequency script based at least in part on the third frequency being different than the second frequency, wherein re-generating the second radio frequency script is based at least in part on the third frequency.

25. The apparatus of claim 18, wherein the instructions are further executable by the processor to cause the apparatus to:
identify a failure of the first portion of the measurement during the second portion of the discontinuous reception cycle; and
re-perform the first portion of the measurement during a fourth portion of a second discontinuous reception cycle subsequent to the discontinuous reception cycle based at least in part on identifying the failure, the second discontinuous reception cycle comprising a third portion prior to the fourth portion, wherein re-performing the first portion of the measurement is based at least in part on the first radio frequency script.

26. The apparatus of claim 18, wherein the instructions are further executable by the processor to cause the apparatus to:
store the first radio frequency script in a database of the UE after generating the first radio frequency script; and
delete the first radio frequency script from the database based at least in part on a success of the first portion of the measurement.

27. The apparatus of claim 18, wherein the instructions are further executable by the processor to cause the apparatus to:
transmit a measurement report comprising an indication of a cell global identity of the cell based at least in part on a success of the measurement.

28. An apparatus for wireless communication at a user equipment (UE), comprising:
a processor;
memory coupled with the processor; and
instructions stored in the memory and executable by the processor to cause the apparatus to:
receive a control message comprising a request to perform a measurement of a cell, the control message comprising an indication of a target frequency associated with the measurement;
generate a first radio frequency script during a first portion of a first discontinuous reception cycle of a plurality of discontinuous reception cycles based at least in part on the target frequency;
acquire a synchronization signal during the first portion based at least in part on the first radio frequency script, the synchronization signal indicating a second frequency associated with the measurement; and
generate a second radio frequency script during a second portion of a second discontinuous reception cycle of the plurality of discontinuous reception cycles based at least in part on the second frequency indicated by the synchronization signal.

29. The apparatus of claim 28, wherein the instructions are further executable by the processor to cause the apparatus to:
acquire, during the second portion of the second discontinuous reception cycle, a system information block based at least in part on the second radio frequency script, wherein the system information block comprises a cell global identity of the cell associated with the measurement.

30. The apparatus of claim 29, wherein the instructions are further executable by the processor to cause the apparatus to:
transmit, during a third discontinuous reception cycle, a measurement report comprising an indication of the cell global identity of the cell based at least in part on acquiring the system information block.
